(19) United States
(12) Patent Application Publication
(10) Pub. No.: US 2024/0085205 A1
(43) Pub. Date: Mar. 14, 2024

(54) METHOD AND APPARATUS FOR MACHINE LEARNING-BASED PREDICTION OF AN ESTIMATED TIME OF ARRIVAL

(71) Applicant: HERE Global B.V., Eindhoven (NL)

(72) Inventors: David JONIETZ, Zürich (CH); Bo XU, Lisle, IL (US); Rohit GUPTA, Son en Breugel (NL); Ali SOLEYMANI, Zürich (CH); Reinhard Walter KÖHN, Berlin (DE)

(21) Appl. No.: 17/941,607

(22) Filed: Sep. 9, 2022

(51) Int. Cl. G01C 21/34; G06N 5/02

(52) U.S. Cl. CPC G01C 21/3484; G06N 5/022

(57) ABSTRACT

An approach is provided for machine learning-based prediction of an estimated time of arrival (ETA) or any other trip characteristic. The approach involves, for example, receiving a request for an ETA (or any other trip characteristic). The request specifies an origin, a destination, and a time of departure. The approach also involves discretizing the origin to an origin ETA homogenous zone and the destination to a destination ETA homogenous zone. The approach further involves determining one or more features of one or more pre-computed k-shortest paths for an origin-destination (O-D) zone pair comprising the origin ETA homogenous zone and the destination ETA homogenous zone. The approach further involves providing the one or more features as an input to a trained machine learning to predict the ETA of the trip (or any other trip characteristic).

### BACKGROUND

Mapping and navigation service providers are making increasing use of machine learning to provide location-based services. Machine learning, for instance, enables service providers to extract underlying spatial and/or semantic relationships between locations and to classify or make predictions based on those relationships or underlying structure (e.g., make traffic-related inferences such as determining estimated times of arrival (ETAs), travel time, and/or the like). However, training machine learning models to understand these spatial/semantic relationships (or perform traffic-related data analytics based on these relationships) typically use considerable data, time, and computing resources. Accordingly, services providers face significant technical challenges with respect to reducing the computational resources used for locations-based analytics and related computations (e.g., ETA computations).

### SOME EXAMPLE EMBODIMENTS

Therefore, there is a need for a resource efficient approach to computing estimated times of arrival (ETAs) or characteristics/attributes of a trip.

According to one embodiment, a method comprises receiving a request for the ETA of the trip (or any other trip characteristic such as but not limited to travel distance, travel speed, etc.). The request specifies an origin, a destination, and a time of departure of the trip. The method also comprises discretizing the origin to an origin ETA homogenous zone and the destination to a destination ETA homogenous zone. The method further comprises determining one or more features associated with one or more pre-computed k-shortest paths between an origin-destination (O-D) zone pair comprising the origin ETA homogenous zone and the destination ETA homogenous zone. The method further comprises providing the one or more features as an input to a trained machine learning to predict the ETA of the trip (or any other trip characteristic). The method further comprises providing the predicted ETA as an output.

According to another embodiment, an apparatus comprises at least one processor, and at least one memory including computer program code for one or more computer programs, the at least one memory and the computer program code configured to, with the at least one processor, cause, at least in part, the apparatus to receive a request for the ETA of the trip (or any other trip characteristics such as but not limited to travel distance, travel speed, etc.). The request specifies an origin, a destination, and a time of departure of the trip. The apparatus is also caused to discretize the origin to an origin ETA homogenous zone and the destination to a destination ETA homogenous zone. The apparatus is further caused to determine one or more features associated with one or more pre-computed k-shortest paths between an origin-destination (O-D) zone pair comprising the origin ETA homogenous zone and the destination ETA homogenous zone. The apparatus is further caused to provide the one or more features as an input to a trained machine learning to predict the ETA of the trip (or any other trip characteristic such as fuel consumption or vehicle emissions). The apparatus is further caused to provide the predicted ETA as an output.

According to another embodiment, a non-transitory computer-readable storage medium carries one or more sequences of one or more instructions which, when executed by one or more processors, cause, at least in part, an apparatus to receive a request for the ETA of the trip (or any other trip characteristics such as but not limited to travel distance, travel speed, etc.). The request specifies an origin, a destination, and a time of departure of the trip. The apparatus is also caused to discretize the origin to an origin ETA homogenous zone and the destination to a destination ETA homogenous zone. The apparatus is further caused to determine one or more features associated with one or more pre-computed k-shortest paths between an origin-destination (O-D) zone pair comprising the origin ETA homogenous zone and the destination ETA homogenous zone. The apparatus is further caused to provide the one or more features as an input to a trained machine learning to predict the ETA of the trip (or any other trip characteristic). The apparatus is further caused to provide the predicted ETA as an output.

According to another embodiment, an apparatus comprises means for receiving a request for the ETA of the trip (or any other trip characteristics such as but not limited to travel distance, travel speed, etc.). The request specifies an origin, a destination, and a time of departure of the trip. The apparatus also comprises means for discretizing the origin to an origin ETA homogenous zone and the destination to a destination ETA homogenous zone. The apparatus further comprises means for determining one or more features associated with one or more pre-computed k-shortest paths between an origin-destination (O-D) zone pair comprising the origin ETA homogenous zone and the destination ETA homogenous zone. The apparatus further comprises means for providing the one or more features as an input to a trained machine learning to predict the ETA of the trip (or any other trip characteristic). The apparatus further comprises means for providing the predicted ETA as an output.

According to one embodiment, a method comprises determining a plurality of origin-destination (O-D) zone pairs for a geographic area. Each O-D zone pair comprises an origin ETA homogenous zone and a destination ETA homogenous zone (or homogenous with respect to any other trip characteristic). The method also comprises grouping a plurality of historical trips by the plurality of O-D zone pairs. Each group of the plurality of historical trips comprises a training example associated with each O-D zone pair. The method further comprises for each O-D zone pair, computing a mean ETA of the plurality of historical trips grouped in each training example, one or more k-shortest paths, and one or more features of the one or more k-shortest paths. The method further comprises respectively labeling each O-D zone pair with the mean ETA. The method further comprises training a machine learning model based on the respectively labeled O-D zone pairs and the one or more features of the one or more k-shortest paths. The machine learning model is trained to determine a predicted ETA (or any other trip characteristic) based on an input O-D zone pair. The method further comprises providing the trained machine learning model as an output.

According to another embodiment, an apparatus comprises at least one processor, and at least one memory including computer program code for one or more computer programs, the at least one memory and the computer program code configured to, with the at least one processor, cause, at least in part, the apparatus to determine a plurality of origin-destination (O-D) zone pairs for a geographic area. Each O-D zone pair comprises an origin ETA homogenous zone and a destination ETA homogenous zone (or homogenous with respect to any other trip characteristic). The apparatus is also caused to group a plurality of historical trips by the plurality of O-D zone pairs. Each group of the plurality of historical trips comprises a training example associated with each O-D zone pair. The apparatus is further caused to, for each O-D zone pair, compute a mean ETA of the plurality of historical trips grouped in each training example, one or more k-shortest paths, and one or more features of the one or more k-shortest paths. The apparatus is further caused to respectively label each O-D zone pair with the mean ETA. The apparatus is further caused to train a machine learning model based on the respectively labeled O-D zone pairs and the one or more features of the one or more k-shortest paths. The machine learning model is trained to determine a predicted ETA (or any other trip characteristic) based on an input O-D zone pair. The apparatus is further caused to provide the trained machine learning model as an output.

According to another embodiment, a non-transitory computer-readable storage medium carries one or more sequences of one or more instructions which, when executed by one or more processors, cause, at least in part, an apparatus to determine a plurality of origin-destination (O-D) zone pairs for a geographic area. Each O-D zone pair comprises an origin ETA homogenous zone and a destination ETA homogenous zone (or homogenous with respect to any other trip characteristic). The apparatus is also caused to group a plurality of historical trips by the plurality of O-D zone pairs. Each group of the plurality of historical trips comprises a training example associated with each O-D zone pair. The apparatus is further caused to, for each O-D zone pair, compute a mean ETA of the plurality of historical trips grouped in each training example, one or more k-shortest paths, and one or more features of the one or more k-shortest paths. The apparatus is further caused to respectively label each O-D zone pair with the mean ETA. The apparatus is further caused to train a machine learning model based on the respectively labeled O-D zone pairs and the one or more features of the one or more k-shortest paths. The machine learning model is trained to determine a predicted ETA (or any other trip characteristic) based on an input O-D zone pair. The apparatus is further caused to provide the trained machine learning model as an output.

According to another embodiment, an apparatus comprises means for determining a plurality of origin-destination (O-D) zone pairs for a geographic area. Each O-D zone pair comprises an origin ETA homogenous zone and a destination ETA homogenous zone (or homogenous with respect to any other trip characteristic). The apparatus also comprises means for grouping a plurality of historical trips by the plurality of O-D zone pairs. Each group of the plurality of historical trips comprises a training example associated with each O-D zone pair. The apparatus further comprises, for each O-D zone pair, means for computing a mean ETA of the plurality of historical trips grouped in each training example, one or more k-shortest paths, and one or more features of the one or more k-shortest paths. The apparatus further comprises means for respectively labeling each O-D zone pair with the mean ETA. The apparatus further comprises means for training a machine learning model based on the respectively labeled O-D zone pairs and the one or more features of the one or more k-shortest paths. The machine learning model is trained to determine a predicted ETA (or any other trip characteristic) based on an input O-D zone pair. The apparatus further comprises means for providing the trained machine learning model as an output.

In addition, for various example embodiments described herein, the following is applicable: a computer program product may be provided. For example, a computer program product comprising instructions which, when the program is executed by a computer, cause the computer to perform any one or any combination of methods (or processes) disclosed.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of machine learning-based prediction of an estimated time of arrival (ETA), according to one example embodiment;

FIG. 2 is a diagram illustrating an example of spatial aggregation for ETA prediction, according to one example embodiment;

FIG. 3 is a diagram of components of a mapping platform capable of providing a machine learning-based ETA prediction, according to one example embodiment;

FIG. 4 is a flowchart of a process for training a machine learning model for ETA prediction, according to one example embodiment;

FIG. 5 is a diagram illustrating a training pipeline for machine learning-based ETA prediction, according to one example embodiment;

FIG. 6 is a diagram illustrating spatial elements for machine learning-based ETA prediction, according to one example embodiment;

FIG. 7 is a flowchart of a process for machine learning-based ETA prediction, according to one example embodiment;

FIG. 8 is a diagram illustrating an example use case of machine learning-based ETA prediction, according to one example embodiment;

FIG. 9 is a flowchart of a process for spatial aggregation for location-based services, according to one example embodiment;

FIGS. 10A and 10B are diagrams illustrating example criteria for spatial aggregation, according to one example embodiment;

FIG. 11 is a flowchart of a process for spatial aggregation based on an evolutionary algorithm, according to one example embodiment;

FIG. 12 is a diagram illustrating an example of using an evolutionary algorithm for spatial algorithm, according to one example embodiment;

FIG. 13 is a flowchart of a process for spatial aggregation based on reinforcement learning, according to one example embodiment;

FIG. 14 is a diagram of a geographic database, according to one example embodiment;

FIG. 15 is a diagram of hardware that can be used to implement an example embodiment of the processes described herein;

FIG. 16 is a diagram of a chip set that can be used to implement an example embodiment of the processes described herein; and

FIG. 17 is a diagram of a terminal that can be used to implement an example embodiment of the processes described herein.

### DESCRIPTION OF SOME EMBODIMENTS

Examples of a method, apparatus, and computer program for machine learning (ML)-based estimated time of arrival (ETA) prediction are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. In addition, the embodiments described herein are provided by example, and as such, “one embodiment” can also be used synonymously as “one example embodiment.” Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

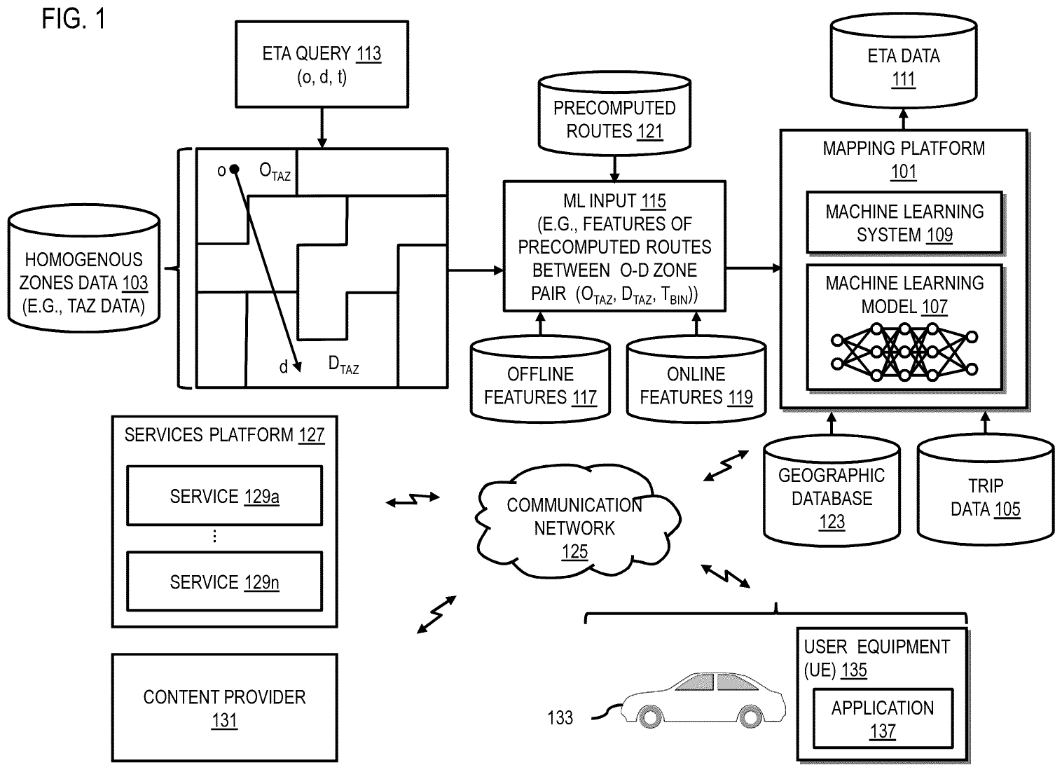

FIG. 1 is a diagram of a system capable of machine learning-based prediction of an estimated time of arrival (ETA), according to one example embodiment. ETA prediction is an important and challenging task in transportation systems. For example, transportation service providers and logistic companies use ETAs to estimate pickup times, match riders to drivers, schedule deliveries, and so on. It is not uncommon that an ETA system must process millions of ETA queries at one time, and thus efficiency (e.g., with respect to computational resources, computation time, etc.) becomes a critical issue.

Generally, there are two types of ETA problems, depending on whether the route to be taken by a trip is known at the time of prediction (e.g., in the case of GPS navigation), or it is not known (e.g., in the case of delivery scheduling). The approach various embodiments described herein have particular applicability to the latter type (although the approach can also be used in the former case). In this case, a conventional ETA system typically predicts the ETA of a trip by computing a plausible route (e.g., the shortest path) between the origin and the destination and then predicting the ETA based on the travel time of the route. Such a conventional paradigm has two limitations. First, computing routes for millions of trips introduces considerable delay and computation resource usage to ETA query processing as each trip route needs to be calculated online (e.g., at the time the ETA request is made such as in real-time). Second, a conventional ETA prediction is based on the travel time of a single route which may not be the actual route traveled in a trip, e.g., due to particular route requirements that are not reflected in the routing algorithm or when a user decides to deviate from the planned or recommended route.

Most of the existing ETA methods follow a route-based approach. Given an origin and a destination, these conventional methods first find a route (e.g., the shortest path) between the origin and the destination and then estimate the travel time for this route. Some of these conventional methods estimate the route travel time by estimating the travel times on each segment of the route and adding them up. Some conventional methods take intersection delays into account as well. Other conventional approaches build ML models to estimate the route travel time based on features such as the geospatial embeddings of the origin and destination, the road segments' historical and real-time travel speeds and times as well as their lengths and functional classifications. Regardless of how the route travel time is estimated, conventional route-based methods share two common limitations: (i) they introduce expensive path computation at the time of prediction; (ii) by considering a single route, they do not account for various route choices of travelers.

The address these technical challenges, the system of FIG. 1 introduces an ETA prediction capability that does not need to compute any route at the time of prediction. In one embodiment, the system (e.g., via a mapping platform 101) discretizes a geographic region into polygon areas referred herein as Travel-time (or Traffic) Analysis Zones (TAZs), ETA homogenous zones, or homogenous zones that are homogenous with respect to ETA or travel times (e.g., stored in homogenous zones data 103). The TAZs or homogenous zones are determined so that the trips originating from a common TAZ are likely to have similar travel times, regardless of their exact start locations within the TAZ. It is noted that ETA and travel times are used synonymously in the various embodiments described because ETA is travel time offset from a departure time. In one embodiment, the system optionally discretizes the time dimension into fixed-length bins, e.g., 30-minute bins. Then, based on a set of historical trips (e.g., trip data 105), the system trains a machine learning (ML) model (e.g., ML model 107 of ML system 109 associated with the mapping platform 101) to predict a plausible average ETA (e.g., ETA data 111). This ETA prediction holds for all trips which depart within a fixed time bin, and which originate anywhere within a TAZ and end anywhere within a different TAZ. For any individual query trip (e.g., ETA query 113 specifying a trip as a tuple comprising origin o, destination d, and departure time t), the respective mean ETA with regards to its TAZ pair (e.g., an O-D zone pair) and optionally time bin will be used as final ETA prediction.

In order to make the prediction, the ML model takes as input (e.g., ML input 115) a set of features (e.g., offline features 117 and/or online features 119), which describe selected characteristics of the “plausible” routes (e.g., pre-computed routes 121) that travelers would take between a pair of TAZs. In one embodiment, an O-D zone pair is discretized from the ETA query 113 as a tuple comprising: (1) the origin TAZ (O_{TAZ}) which identifies the homogenous zone in which the origin o of the trip is located, (2) the destination TAZ (D_{TAZ}) which identifies the zone in which the destination d of the trip is located, and optionally (3) the departure time bin (T_{BIN}) in which the departure time t of the trip falls. In the various embodiments described herein, the time component is optional because the ETA prediction can be determined based solely on the O-D zone pair (e.g., a pair specifying the O_{TAZ} and D_{TAZ}) with departure time as an optional feature for further refining the ETA prediction by considering possible temporal variations of ETAs. In one embodiment, some features (e.g., offline features 117) are pre-computed based on the k-shortest paths (e.g., taken from pre-computed routes 121) that connect the origin TAZ with the destination TAZ (e.g., in a O-D zone pair). Examples of offline features 117 include but are not limited to the mean speed limit of road segments, the fraction of road segments belonging to certain functional classes, or the sum of left turn angles. These offline features 117 are pre-computed for all or a selected portion of TAZ pairs (e.g., O-D zone pairs) within a geographic agree and then fetched at the time of prediction to determine the ML input 115. In addition or alternatively, the system 100 can use features computed online (e.g., online features 119) at the time of prediction, such as but not limited the real-time traffic conditions, real-time weather conditions, and/or the like on the k-shortest paths (e.g., taken from pre-computed routes 121 for a given O-D zone pair).

In one embodiment, whether the features the k-shortest paths are pre-computed (e.g., offline features 117) or online computed features (e.g., online features 119), the k-shortest paths associated with the features are always pre-computed (e.g., in pre-computed routes 121). Therefore, there is no need to compute any route at the time of prediction. Furthermore, the k-shortest paths serve better than a single route for representing various route choices that travelers might make.

Since the approach of the various embodiments described herein is based on machine learning from spatio-temporally aggregated historical trips, the approach is also referred to herein as Spatio-Temporal Aggregated Machine-learning Prediction (STAMP). In summary, the STAMP approach of the various embodiments described herein has the at least the following advantages:
It does not need to compute any route at the time of prediction, and it does not need to know the routes taken by historical trips. Furthermore, all features except the real-time features can be computed offline. These properties reduce the computational cost at the time of prediction and lead to faster query responses.
It considers multiple route choices of travelers rather than a single route. This allows the ETA prediction to “cover” more possibilities and mimic the stochasticity that exists in real data.
It discretizes a geographic region into ETA homogeneous zones (e.g., TAZs) and creates features to capture the road characteristics and traffic patterns between zone pairs (e.g., O-D zone pairs).
It aggregates historical trips based on spatio-temporal discretization. Aggregation is achieved when trips for an O-D zone pair are averaged for a given time bin into a single training example. During online prediction, a trained model is used to predict ETA for individual trips regardless of whether their O-D zone pair and/or departure time bin has been seen in the training set or not. This ability to generalize across space and time strongly indicates that the model (e.g., trained ML model 107) learns not simple dictionary-like mappings, but rather general patterns of correlation between characteristics of the underlying road network, route probabilities, and dynamic traffic conditions on the one hand and observed ETAs on the other hand.
It does not use any trip route in either the training stage or the prediction stage, which makes it well-suited for scenarios where the exact routes are unknown.
It is customizable for a given domain because the predicted ETAs are learned directly from data, thereby opening up the potential for customization (e.g., to specific users such as but not limited to delivery businesses).

Although the various embodiments described herein can use homogenous zones data 103 (e.g., TAZs or geographic partitions) generated according to any method or process. In one embodiment, the various embodiments of the ETA prediction approach described herein can be further optimized by providing an optimized spatial aggregation process to generate TAZs (e.g., optimized with respect to minimizing the number of TAZs while ensuring that the TAZs are also homogenous with respect to ETA of trips from or to the zone).

For example, the various embodiments above use an ETA query 113 that specifies an origin o and destination d as point locations that can occur at any continuous location coordinates within a geographic. Because trips can start at any origin and end at any destination within a geographic area of interest, the total number of possible o-d pairs can be large. With respect to data analysis of these o-d pairs (e.g., via ML system 109 for ETA prediction), the large total number of o-d pairs presents significant technical challenges because of limitations on computing resources available to process the large number of o-d pairs. For applications such as machine learning that rely on having multiple observations of the same o-d pair for training (e.g., ETA prediction), data sparsity can also present significant technical challenges.

To address these additional technical challenges, the system of FIG. 1 introduces a capability (e.g., via a mapping platform 101) to discretize the digital map data representing a road network or geographic area (e.g., digital map data of a geographic database 123) into homogenous zones or TAZs (e.g., polygon areas, grid cells, and/or other bounded areas of the homogenous zones data 103 representing a geographic area of interest). The TAZs are homogenous such that the trips originating from a common TAZ are likely to have similar trip characteristics (e.g., ETAs, travel distances, travel speed, traffic volume, fuel consumption, vehicle emissions, etc.) regardless of their exact start locations or origins within the TAZ. It is noted that the terms TAZ, homogenous zones, and partitions are used synonymously in the various embodiments described herein. It is also noted that although the various embodiments described herein are discussed with respect to predicting an ETA of a trip. However, it is contemplated that the embodiments are also applicable predicting any other trip characteristic (e.g., travel distances, travel speed, traffic volume, fuel consumption, vehicle emissions, etc.) associated with trips between O-D zone pairs.

In one embodiment, the discretization starts with dividing the road network or geographic area of interest into grid cells or any other kind of initial partitions. Then, the grid cells or partitions are aggregated to create TAZs. This procedure is referred to herein as spatial aggregation.

In one embodiment, spatial aggregation merges cells or partitions in the initial grid together that have similar trip characteristics (e.g., ETAs, travel times, travel distances, fuel consumption, vehicle emissions, etc.) to decrease the total number of possible O-D TAZ pairs/O-D zone pairs. The term “similar,” for instance, refer to trip characteristics that meet a similarity threshold or criteria to be classified as “homogenous” such that two partitions or cells can be merged into one TAZ, homogenous zone, or other larger partition. The resulting merged homogenous zones, TAZs, or partitions are output as homogenous zones data 103 (e.g., TAZ data). By way of example, a reduction of possible O-D zone pairs can lead to more historical trips per O-D zone pair, which effectively increases the density of training data and thereby simplifies the predictive task (e.g., associated with ETA prediction). Furthermore, with a reduction of possible O-D zone pairs, fewer feature values are needed for the same number of historical trips, which saves memory and computation time for training.

However, a high reduction of possible O-D zone pairs often is based on a TAZ that merges many cells. This usually results in a large variance in a trip characteristics of interest (e.g., ETA) among the trips that originate from the TAZ, which is against the criterion that a TAZ should be homogeneous with respect to one or more selected trip characteristics. It is noted that ETA is provided by way of illustration of a trip characteristics and is not a limitation. It is contemplated that in various example embodiments where ETA is mentioned alone, the example embodiments are also applicable to any other trip characteristic (e.g., travel distance, travel speed, etc.). Thus, approach of the various embodiments described herein is facing at least two contradictory goals, namely reducing possible O-D zone pairs versus retaining trip characteristic homogeneity (e.g., ETA homogeneity). The various embodiments of spatial aggregation described herein are aimed at reaching a balance between these two goals.

The approach of the various embodiments described herein differs from conventional community detection algorithms in at least two aspects. First, the various embodiments described herein do not consider modularity as a metric for decision making on merging similar spatial units. Second, the various embodiments described herein do not impose pre-defined geographical regions (e.g., municipalities) as the starting point of spatial aggregation. Instead, the various embodiments described herein utilize the information contained in the trip data 105 and make aggregation decisions based on how the trips are spatially distributed to generate merged homogenous zones data 103.

In one embodiment, the various embodiments described herein can accept any kind of partitions as initial partitions, whether they are grid cells, administrative zones such as tracts, or partitions based on natural boundaries such as rivers, or a combination of these. In summary, the various embodiments described herein aggregate chunks or partitions of geographical tracts (also referred to synonymously as TAZs) into larger units or partitions based on some characteristics of the trips originating from each TAZ. In one embodiment, if the characteristics of two or more TAZs are within a certain margin, threshold, or criteria, the system considers the two or more TAZs identical and merges them into a single TAZ (e.g., for storage and/or use in homogenous zones data 103). The outcome of the various embodiments of spatial aggregation described herein reduces the total number of TAZs and consequently, reduces the number of data samples that are to be processed downstream (e.g., for ML-based ETA prediction). Specifically, it reduces the number of distinct possibilities the ETA prediction task must at a given time choose from and/or learn.

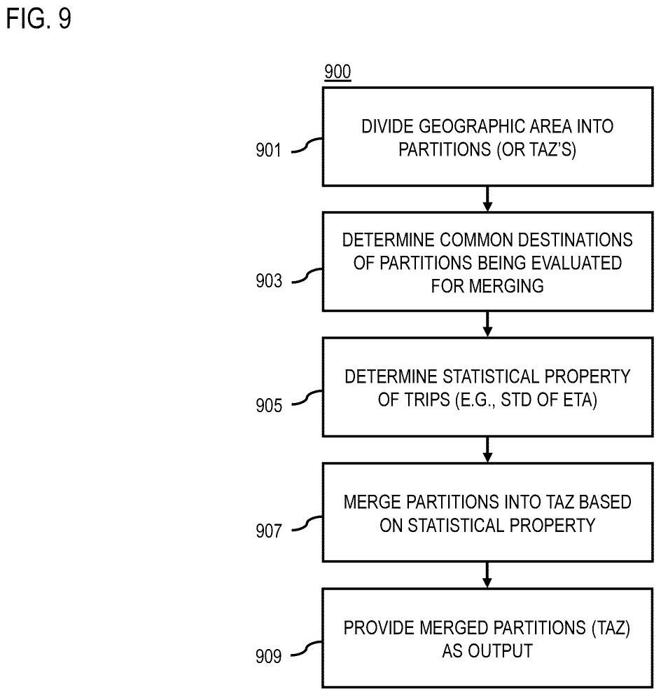

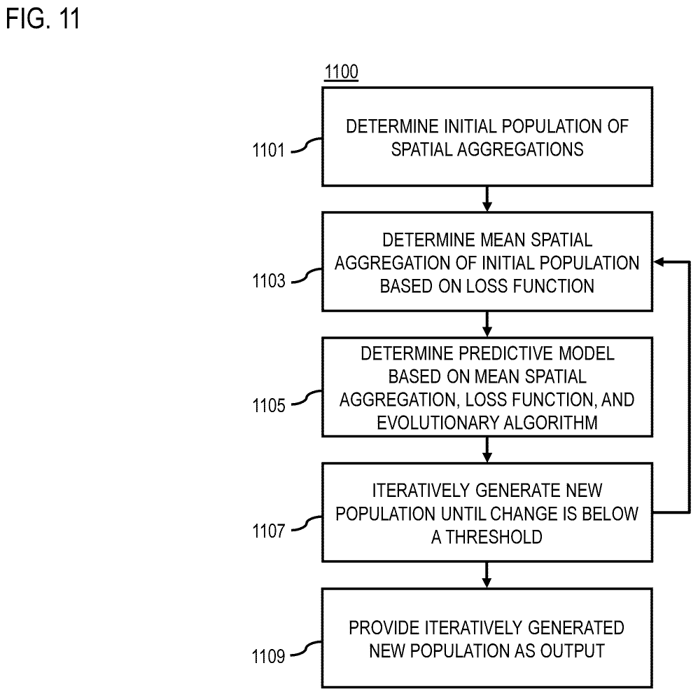

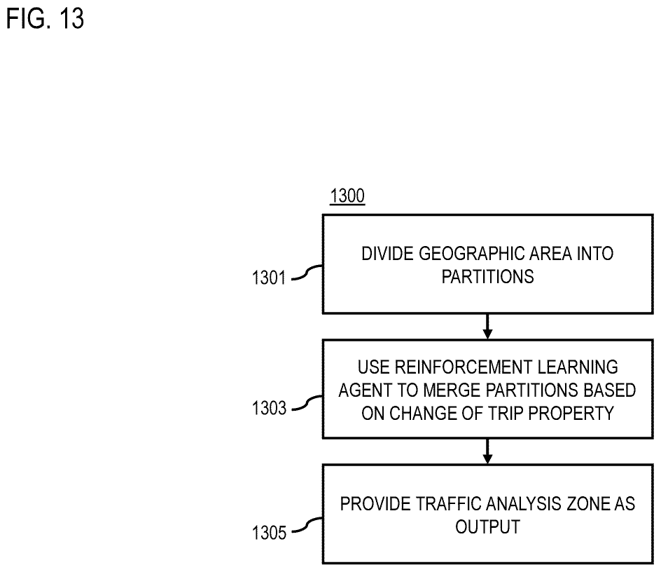

In one embodiment, the spatial algorithm can be performed heuristically according to the aggregation algorithm (e.g., as described with respect to spatial aggregation process 900 of FIG. 9 below). In addition or alternatively, spatial aggregation can be performed using a machine learning-based approach. For example, the mapping platform 101 can use a machine learning model based on an evolutionary algorithm to evolve (e.g., using a loss function based on a statistical property of a trip characteristic such as but not limited to the standard deviation of an ETA) an initial population of candidate aggregations representing a geographic area to an evolved or improved population as described in more detail with respect to the process 1100 of FIG. 11 below. The term “improved,” in one embodiment, refers a new population of aggregation candidate that minimizes loss based on the loss function (e.g., minimizes changes to a standard deviation of ETA between two iterative populations of aggregation candidates). In another embodiment, spatial aggregation can be performed by using a machine learning model based on reinforcement learning where the learning agent uses the loss function (e.g., based on a statistical property of a trip characteristic) as a reward as described in more detail with respect to the process 1300 of FIG. 13 below.

As described previously, the system iteratively processes neighboring partitions or TAZs for merging until convergence or other stopping criteria are met. For example, if a predetermined number of iterations fails to result in any additional mergers or all immediate neighboring partitions or TAZs have been processed without merging, then the iterative spatial aggregation process can stop. On reaching the convergence or stopping criterion, the one or more resulting merged TAZs can be output as homogenous zones data 103. It is contemplated that the homogenous zones data 103 can be transmitted over a communication network 125 and used for any application, service, or tasks including but not limited to ML-based ETA prediction according to the various embodiments described herein, or those associated a services platform 127, one or more services 129a-129n (also collectively referred to as services 129) of the services platform 127, a content provider 131, and/or any other component of the system or with connectivity to the system.

By way of example, as described with respect to the various embodiments, one use case of the merged homogenous zones data 103 is for predicting the ETA (ETA data 111) of a query trip under the condition that the route to be taken is unknown. Unlike conventional approaches which compute a plausible route for the query trip and predict an ETA based on the computed route, an example embodiment of this use case does not need to compute any route at the time of ETA prediction. Instead, initial partitions of a road network are aggregated into ETA homogeneous zones (e.g., TAZs) according to the various embodiments described herein, and pre-computes k-shortest paths (e.g., pre-computed routes 121) between each TAZ pair/O-D zone pair to accommodate various route choices of travelers. The system then builds a machine learning model 107 using expressive features created based on the k-shortest paths for ETA prediction. These features capture the road characteristics and traffic patterns between a zone pair, without concerning the exact origin/destination location within a zone. The predicted ETA data 111 can then be provided to end user devices such as but not limited to a vehicles 133, user equipment (UE) device 135, and/or location-based application 137 executing on the UE device 135 and/or vehicles 133.

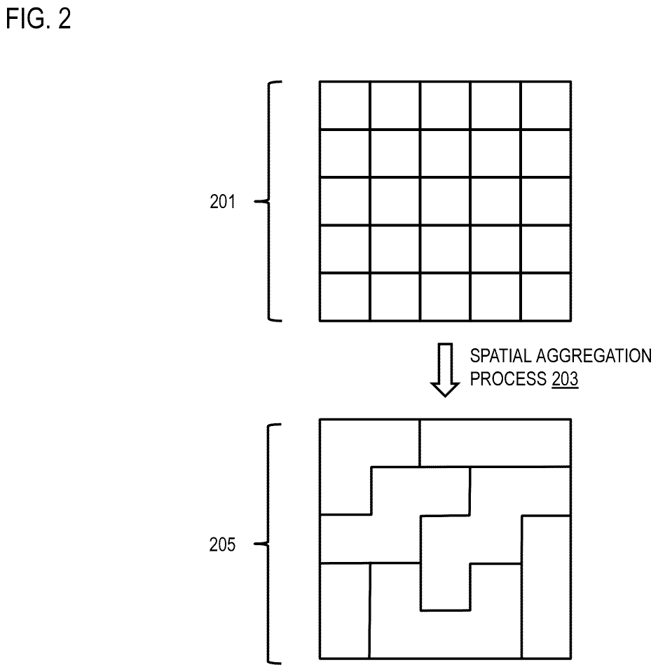

FIG. 2 is a diagram illustrating an example of spatial aggregation for ETA prediction, according to one example embodiment. As shown, a geographic area has been divided into a five-by-five grid 201 of cells that represent an initial or naïve partitioning of the geographic area. Historical trip data associated with each of the grid cells (i.e., partitions) are collected and analyzed for spatial aggregation (e.g., via spatial aggregation process 203) according to the various embodiments described herein. The spatial aggregation process 203 results in generating merged TAZ data 205 (e.g., homogeneous zones) in which the original 25 grid cells/partitions of the grid 201 has been merged into a total of seven TAZs, thereby achieving a 25-to-7 TAZ reduction.

The various embodiments described herein provide for several technical advantages. For instance, as shown in the example of FIG. 2, the various embodiments described herein advantageously provide for efficient reduction in total TAZ count to represent the same geographic area or road network. By way of example, if a region is divided into 100×100 TAZs, then there would be 100 million possible outcomes (e.g., O-D pairs) to perform data analytics (e.g., get ETA predictions) on from the network in the worst case. The various embodiments of spatial aggregation can be used to reduce the amount of TAZs by a significant percentage. For example, a 65% reduction of the 100×100 TAZs can reduce the number of possibilities to predict down to 1.5 million. Such a reduction provides for significant reduction in required resources when training a neural network or performing ETA prediction tasks or other data analytics.

Other technical advantages include but are not limited to:
(1) Data based partitioning—in the various embodiments described herein, there is no need to use municipal regions or any previously defined geographical division or aggregation and instead use the patterns in our data. This is relevant and has a direct consequence on the downstream training and prediction task (e.g., ETA prediction).
(2) Configurable rules for partitioning—The rules and/or criteria for merging partitions (e.g., merging threshold values, specific trip characteristics to use, specific statistical property to use, etc.) are based on the available trip data 105 or related data about the geographic area or road network. As a result, these rules and/or criteria can be modified easily to achieve a new spatial partitioning.
(3) Generalization—for O-D pairs that may not occur in the training data but might occur at the inference stage, if they belong to a TAZ for which the model has been trained the model can still make inferences (e.g., predict an ETA or other trip characteristics according to the various embodiments described herein).

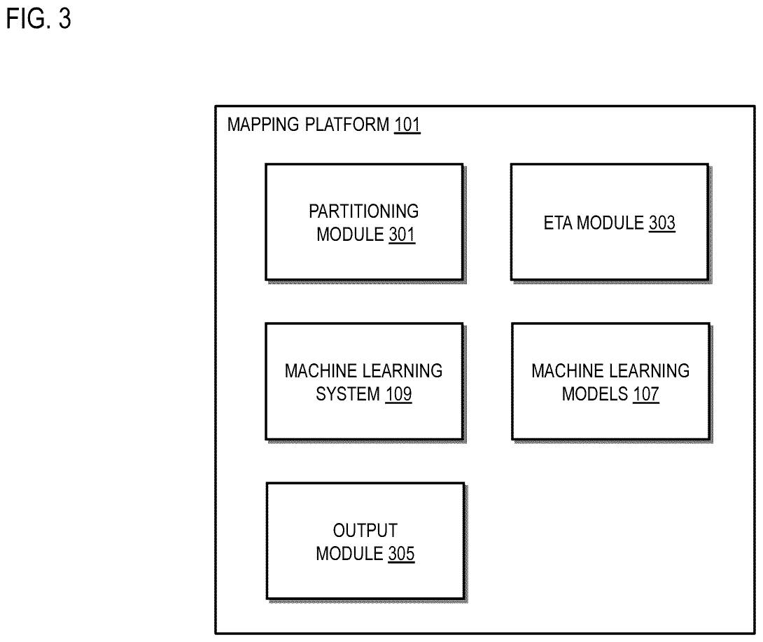

FIG. 3 is a diagram of components of a mapping platform capable of providing a machine learning-based ETA prediction, according to one example embodiment. In one embodiment, as shown in FIG. 3, the mapping platform 101 of the system includes one or more components for machine learning-based ETA prediction according to the various embodiments described herein. It is contemplated that the functions of the components of the mapping platform 101 may be combined or performed by other components of equivalent functionality. As shown, in one embodiment, the mapping platform 101 includes a partitioning module 301, an ETA module 303, the machine learning system 109, one or more machine learning models 107, and an output module 305. The above presented modules and components of the mapping platform 101 can be implemented in hardware, firmware, software, circuitry, or a combination thereof. Though depicted as a separate entity in FIG. 1, it is contemplated that the mapping platform 101 may be implemented as a module of any of the components of the system (e.g., services platform 127, services 129, content providers 131, vehicles 133, UEs 135, and/or the like). In another embodiment, one or more of the modules or components of the mapping platform 101 may be implemented as a cloud-based service, local service, native application, or combination thereof.

The functions of the mapping platform 101 and its modules/components are discussed with respect to figures below. The denotations and terms used in the description of the various embodiments include:
o, d, t: the origin location, destination location, and departure time of a trip, respectively (e.g., where the locations are expressed as point location coordinates or other point location designation, and the time is expressed as a timestamp such as hh:mm:ss).
O, D, T: the TAZ or homogenous zone that o falls into, the TAZ or homogenous zone that d falls into, and the time bin that t falls into, respectively (e.g., discretized versions of o, d, t).
Definition 1: An ETA query (e.g., ETA query 113) is a tuple (o, d, t), asking for the estimated time of arrival (ETA) at d if a traveler starts at o with departure time being t. Since ETA is equal to t plus the travel time from o to d, answering an ETA query is equivalent to computing a travel time. For this reason, in this paper we will use ETA to also refer to the travel time from o to d.
Definition 2: A historical trip (e.g., trip stored in trip data 105) is a tuple (o, d, t, y) indicating a trip that departed at time t, started at o, ended at location d, and had ETA equal toy. Trip data 105 is a dataset of historical trips for ML model training.

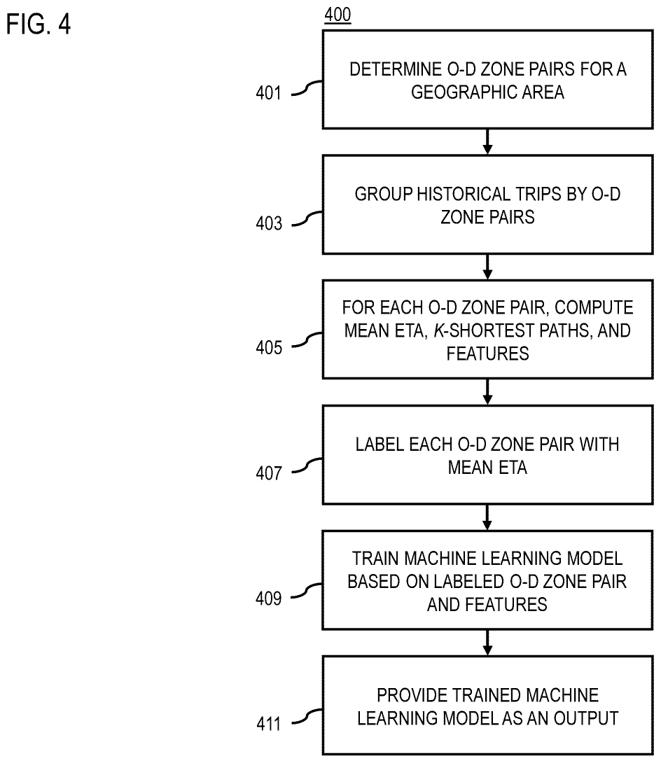

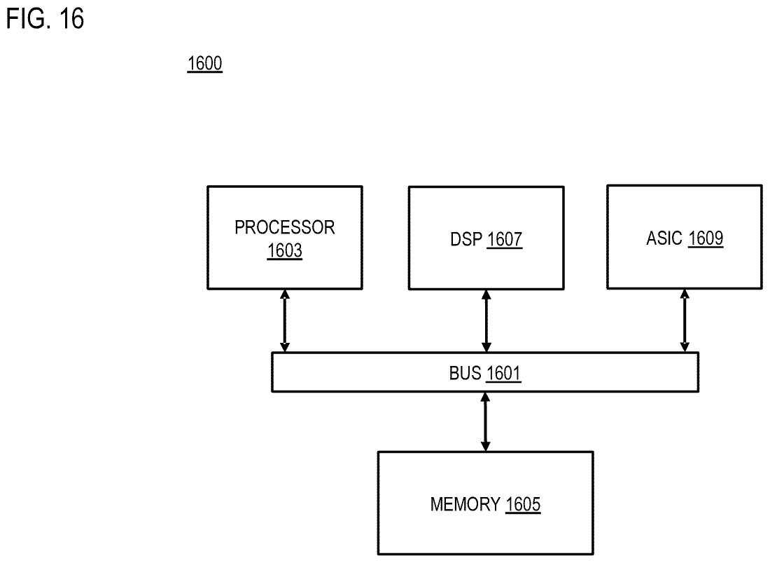

FIG. 4 is a flowchart of a process 400 for training a machine learning model for ETA prediction, according to one example embodiment. In various embodiments, the mapping platform 101 and/or any of its modules/components may perform one or more portions of the process 400 and may be implemented in, for instance, a chip set including a processor and a memory as shown in FIG. 16. As such, the mapping platform 101 and/or any of its components/modules can provide means for accomplishing various parts of the process 400, as well as means for accomplishing embodiments of other processes described herein in conjunction with other components of the system 100. Although the process 400 is illustrated and described as a sequence of steps, it is contemplated that various embodiments of the process 400 may be performed in any order or combination and need not include all of the illustrated steps.

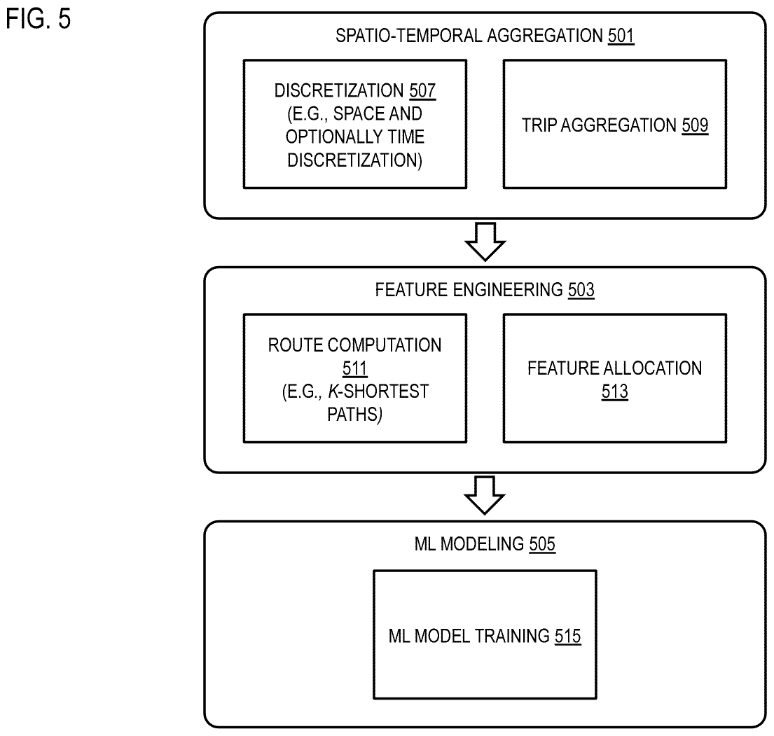

In one embodiment, as shown in FIG. 5, the process 400 is implemented as a training pipeline comprising a spatio-temporal aggregation process 501, feature engineering process 503, and ML modeling process 505. By way of example, the spatio-temporal aggregation process 501 includes: (1) discretization 507 of space and optionally time where origin and destination locations are converted from continuous values to discrete non-continuous values (e.g., discrete zones representing a defined portion of the geographic area of interest into which the origins and destinations fall, or discrete time bins (e.g., 30 minute time bins) into which a departure time value falls); and (2) trip aggregation 509 that aggregates trips with ETAs (e.g., historical trips in trip data 105) in an ML training set (e.g., by allocating each trip to a TAZ/O-D zone pair and optionally time bin, and calculating the mean ETA for every TAZ/O-D zone pair or tuple of every TAZ/O-D zone and time bin if time is considered). The feature engineering process 503 includes, e.g.: (1) route computation 511 to compute the k-shortest paths (KSPs) for TAZ/O-D zone pairs and extract associated road network/geographical attributes; and (2) feature allocation 513 to engineer expressive features and allocate to each TAZ/O-D zone pair. The ML modeling process 505 then trains ML models (e.g., ML models 107) to predict mean ETAs based on the engineered features, see 515. Additional details of the training pipeline are illustrated in the steps below.

In step 401, the partitioning module 301 determines a plurality of origin-destination (O-D) zone pairs for a geographic area. Each O-D zone pair, for instance, comprises an origin ETA homogenous zone (or a homogenous zone with respect to any other selected trip characteristic) and a destination ETA homogenous zone (or a homogenous zone with respect to any other selected trip characteristic). The origin ETA homogenous zone, the destination ETA homogenous zone, or a combination thereof, for instance, represents one or more spatial aggregations of the geographic area in which a standard deviation of the ETA at one or more common destinations is below a threshold value. In other words, an initial step of the process 400 is based on partitioning a geographic area in TAZs or homogenous zones. In one embodiment, the partitioning process includes one or more of the following sub-steps:
(1) Divide the geographic area into a grid (or any type of partition), wherein each cell is a square with side length equal to z; z is a system parameter, e.g., 250 meters.
(2) Run a spatial aggregation algorithm to aggregate the cells into TAZs, homogenous zones, partitions, etc. The algorithm minimizes the number of TAZs while keeping the standard deviation of the ETAs (or any other selected trip characteristic) originating from each TAZ below a threshold. One example of spatial aggregation is described with respect to the FIGS. 9-13 below. It is noted that the various embodiments of spatial aggregation described is provided by way of illustration and not as limitations. Accordingly, it is contemplated that any spatial aggregation process or none at all (e.g., provided there is an initial set of geographic partitions from with O-D zone pairs can be determined) can be used according to the various embodiments described herein.
(3) Optionally eliminate the TAZs that do not intersect any road (e.g., to advantageously further reduce the number TAZs or homogenous zones to process).

In step 403, the partitioning module 301 groups a plurality of historical trips by the plurality of O-D zone pairs to begin the training process. Each group of the plurality of historical trips comprises a training example associated with each O-D zone pair. As previously discussed, each trip of the plurality of trips is represented as a tuple comprising, at least in part, a trip origin point, a trip destination point, a trip time of departure, and a trip ETA.

In one embodiment, the plurality of historical trips is further grouped based on a plurality of departure time bins in combination with the plurality of O-D zone pairs; and wherein the mean ETA, the one or more k-shortest paths, the one or more features, or a combination thereof is computed based on the plurality of departure time bins.

In step 405, for each O-D zone pair, the partitioning module 301 computes a mean ETA of the plurality of historical trips grouped in each training example, one or more k-shortest paths, and one or more features of the one or more k-shortest paths. Details of these computations are discussed in more detail below starting with route calculation.

In one embodiment, to compute the k-shortest paths for each O-D zone pair, the partitioning module 301 determines a representative origin point in the origin ETA homogenous zone and a representative destination point in the destination ETA homogenous zone. By way of example, the representative origin point, the representative destination point, or a combination is determined based on a minimum distance sum of a plurality of distances between a plurality of cells respectively comprising the origin ETA homogenous zone or the destination ETA homogenous zone. The one or more k-shortest paths are determined based on the representative origin point and the representative destination point (e.g., using those points as the origin and destination in a routing algorithm).

In other words, once TAZs or homogenous zones are created (e.g., homogenous zones data 103), the partitioning module 301 calculates a representative point for each TAZ in the O-D zone pair and snaps the representative point to the closest point on of road network or other geographic features occurring the geographic area represented by the TAZ. It is contemplated that any process can be used to select a representative provided that representative point occurs within the boundary of the corresponding TAZ or homogenous zone.

One example but not exclusive process to calculate a representative point includes the following. Let Z be a TAZ and S be the set of initial partition cells that constitute Z. The representative point of Z is calculated as follows:
(1) Compute the center of each (square) cell in S.
(2) For each cell in S, compute the sum of the distances between the cell's center and each other cell's center. Call this sum a distance sum.
(3) The representative point is the center that has the minimum distance sum.

Notice that the representative point calculated as above is guaranteed to be inside Z. This is why, in one embodiment, the partitioning module 301 is not using Z's centroid which would have been easier to calculate. The centroid of Z may be outside Z in the case that Z is concave. But, in this embodiment, the partitioning module 301 is configured to determine representative point to be inside Z because every k-shortest path the partitioning module 301 computes for Z should start from somewhere inside Z. In cases where there are no concave TAZs or homogenous zones, the partitioning module 301 can compute the centroid as the representative point.

Then, for each TAZ pair O and D (e.g., each O-D zone pair), the partitioning module 301 computes k-shortest paths that start at O's snapped representative point and end at D's snapped representative point. In one embodiment, the k-shortest paths are computed to be substantially different from each other and yet be as short as possible. It is contemplated that any navigation routing algorithm known in the art can be used to determine the k-shortest paths including but not limited to commercial routing services, as well as the direct generation of k-shortest paths from sensor data like GPS probes. By way of example, GPS probe include but are not limited to probe or trajectory data collected from location of sensors of probe vehicles or devices (e.g., vehicles 133 and/or UEs 135) traveling within the geographic area of interest, where the GPS probes comprise individual probe points identifying the probe vehicle or device's location (e.g., latitude, longitude) at a time t.

In one embodiment, the partitioning module 301 then computes features based on the k-shortest paths for all possible TAZ/O-D zone pairs. It is contemplated that the features include but are not limited to features related to the underlying road network and/or geographic features associated with k-shortest paths and/or the TAZs/homogenous zones of the O-D zone pairs. Examples of the computed features include but are not limited to:
(1) Length features: the minimum/maximum/mean/standard deviation of the lengths of the k-shortest paths. These features represent trip lengths under various route choices.
(2) Functional class features: the fraction of k-shortest path road segments of different road categories, e.g., highway, arterial road, local street, etc.
(3) Lane count features: the fraction of K k-shortest path road segments with different lane counts, e.g., 1-lane, 2-lane, 3-lane, etc.
(4) Intersection features: the average number of intersections on each k-shortest path.
(5) Turn angle features: the minimum/maximum/mean/standard deviation of the left/right turn angle sums of the k-shortest paths. These features serve as a proxy of turn delays at intersections.
(6) Travel time features: the minimum/maximum/mean/standard deviation of the travel times of the k-shortest paths under the condition that each road segmented is traveled with its speed limit. Similarly for free flow speed, historical normal speed, and real-time speed. These features represent ETAs under various route choices and traffic conditions.
(7) Jam factor features: (i) the jam factor of the shortest path of the k-shortest paths, wherein the jam factor is defined to be the ratio of the free flow travel time to the real-time travel time; (ii) the length-weighted average of the jam factors of all the k-shortest paths except the shortest path. The jam factor features represent how much congestion there is along the “corridor” between an origin and a destination.
(8) Anomaly factor features: (i) the anomaly factor of the shortest path of k-shortest paths, wherein the anomaly factor is defined to be the ratio of the historical normal travel time to the real-time travel time; (ii) the length-weighted average of the anomaly factors of all the k-shortest paths except the shortest path. These features represent how anomalous the real-time traffic condition is compared with the normal situation.
(9) Discretization error features: (i) the mean distance between the o location of a trip and the representative point of the O_{TAZ}; (ii) the mean distance between the d location of a trip and the representative point of the D_{TAZ}. The discretization error features represent the loss of accuracy caused by spatial discretization.
(10) Location features: geocoordinates (e.g., latitude, longitude) of the representative point of the origin/destination TAZs.
(11) Weather features: The mean precipitation, wind, temperature, visibility, atmospheric pressure levels, and any other weather parameter over the TAZ(s)/homogenous zone(s) of interest.
(12) Optional time features: the day of the week and the minute of the day of the departure time bin.

It is contemplated that the features can be offline or online features. For example, out of the features listed above, lengths, speed limit travel times, free flow travel times, and historical normal travel times are offline features in the sense that they can be pre-computed for every TAZ/O-D zone pair and retrieved at the time of prediction. The other features, such as real-time travel times and weather features are online features in the sense that their values are computed at the time of prediction. Notice that even though the real-time travel time features of the k-shortest paths are computed online, the expensive route computation for the k-shortest paths themselves is done offline, thanks to spatial discretization. In other words, the k-shortest paths for all or a portion of O-D zone pairs for a geographic area of can be computed because the number of possible O-D pairs has been greatly reduced because of discretization (e.g., transformation of origins o and destinations d from continuous location values to corresponding TAZs/homogenous zones).

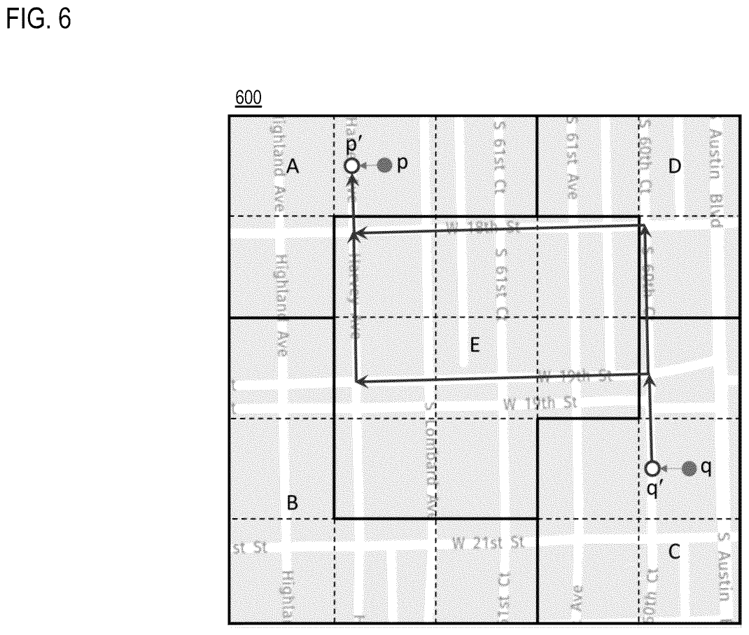

FIG. 6 is a diagram 600 illustrating various spatial elements for machine learning-based ETA prediction, according to one example embodiment. The dashed lines show the initial grid partition of the geographic area. The solid lines show the aggregated TAZs (e.g., generated according to the various embodiments of spatial aggregation described herein). The solid circles p and q are the representative points of TAZ A and TAZ C, respectively. The empty circles p′ and q′ are the respective representative points p and q snapped to the nearest road segment (e.g., snapped using any map-matching algorithm known in the art). The arrowed lines are k=2 shortest paths from q′ top′.

In one embodiment, the partitioning module 301 stores the one or more k-shortest paths (e.g., in the pre-computed routes database 121), the one or more features (e.g., in the offline features database 117) of the one or more k-shortest paths, or a combination thereof. The one or more stored k-shortest paths, the one or more stored features, or a combination thereof can then be retrieved at a time the trained machine learning model is used for prediction. In this way, the k-shortest paths need not be calculated for each ETA query 113 at the time of an ETA prediction is requested, thereby reducing computation resources and processing time to complete an ETA query 113 when the ETA prediction is requested.

In another embodiment, instead of a single representative point for each TAZ, a plurality of representative points is created. These points may be random points within the boundary of the TAZ. They may also be created by clustering the origin locations of the historical trips that originate from the TAZ and finding the cluster centers; in this case the representative points are locations that are most likely to originate trips. Then k-shortest paths are computed between each pair of O-D representative points and features are computed out of all these paths. For example, if n representative points are created for the origin TAZ and the destination TAZ respectively, then there are totally n²·k paths from which features are computed for the O-D TAZ pair.

In one embodiment, the plurality of historical trips (e.g., trip data 105) are grouped by O-D pair so that each group of trips that correspond to a single O-D represents a single training example in a training data set. In other words, given a set of historical trips wherein each trip is a tuple (o, d, t, y) as defined above, the training stage starts with aggregating the trips based on their origin/destination TAZs and departure time bins to create training examples as follows:
(1) Compute the origin homogenous zone O_{TAZ}, destination homogenous zone D_{TAZ}, and departure time bin T_{BIN} for each historical trip based on each trip's respective origin location o, destination location d, departure time t. In other words, discretize the (o, d, t) of each historical trip.
(2) Group the historical trips by O-D zone pair (O_{TAZ}, D_{TAZ}, T_{BIN}). Each group forms one training example.
(3) Compute the mean ETA for each group. For example, each historical trip is a tuple of (o, d, t, y) where y is the ETA observed for each respective historical trip. Thus, the mean ETA for each group (e.g., the set of historical trips grouped associated with an individual O-D zone pair) can be computed as follows:

mean ETA_{G}=mean[y₁,y₂, . . . ,yᵢ]
where G is a group of historical trips corresponding to an O-D zone pair, y is the ETA of a historical trip in the group G, and i is the number of historical trips in the group G.

In step 407, the partitioning module 301 respectively labels each O-D zone pair with the mean ETA. In other words, the computed mean ETA for each group is annotated as the ground truth ETA for each training example corresponding to an O-D zone pair. In one embodiment, there is a training example for each O-D zone pair on which the ML model 107 is to be trained. As discussed in the various embodiments above, one or more features associated with the k-shortest paths between the O_{TAZ} and D_{TAZ} of each O-D zone pair are also computed and associated with each training example. Thus, the ground truth mean ETA label is also associated with the corresponding features. In this way, a training example for a given O-D zone pair includes a ground truth label (e.g., computed mean ETA) and corresponding features of the k-shortest paths between the O-D zone pair.

In step 409, the machine learning system 109 trains a machine learning model 107 based on the respectively labeled O-D zone pairs and the one or more features of the one or more k-shortest paths. The machine learning model 107, for instance, is trained to determine a predicted ETA based on an input O-D zone pair. In one embodiment, if temporal or time bin training data is provided, the machine learning is further trained to determine the predicted ETA with respect to the plurality of departure time bins. It is noted that the training stage does not use the actual route taken by the historical trips (which may not be known after all), only their O-D zone pair and optionally time bin.

In one embodiment, multiple different loss functions and/or supervision schemes can be used alternatively or together to train the machine learning model 107 to determined ETA predictions based on training data set described in the above embodiments. One example scheme is based on supervised learning. For example, in supervised learning, the machine learning system 109 can incorporate a learning model (e.g., a logistic regression model, Random Forest model, and/or any equivalent model) to train the machine learning model 107 to make predictions (e.g., ETA predictions or predictions of any other trip characteristic) from input features or signals (e.g., features extracted from the k-shortest paths between O-D zone pairs). During training, the machine learning system 109 can feed feature sets from a training data set into the machine learning model 107 to compute a predicted ETA or any other trip characteristic using an initial set of model parameters. The machine learning system 109 then compares the predicted matching probability and the predicted ETA or trip characteristic to ground truth data in the training data set for each training example (e.g., labeled mean ETA for each O-D zone pair) used for training. The machine learning system 109 then computes an accuracy of the predictions (e.g., via a loss function) for the initial set of model parameters. If the accuracy or level of performance does not meet a threshold or configured level, the machine learning system 109 incrementally adjusts the model parameters until the machine learning model 107 generates predictions at a desired or configured level of accuracy with respect to the annotated labels in the training data (e.g., the ground truth data). In other words, a “trained” machine learning model 107 has model parameters adjusted to make accurate predictions (e.g., ETA predictions) with respect to the training data set. In the case of a neural network, the model paraments can include, but are not limited, to the coefficients or weights assigned to each connection between neurons in the layers of the neural network.

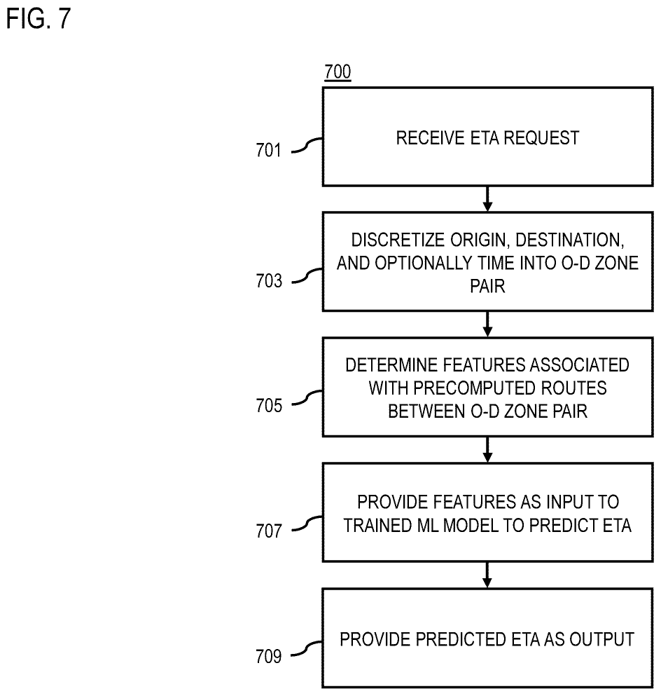

In step 411, the output module 305 provides the trained machine learning model 107 as an output. In one embodiment, the mapping platform 101 can store the trained machine learning model 107 can deploy instances of the trained machine learning model 107 to make ETA predictions or predictions of any trip characteristic for which the model 107 has been trained. By way of example, the trained machine learning model 107 can be instantiated to make predictions at the mapping platform 101, services platform 127, services 129, content provider 131, application 137, and/or any other component of the system 100 or with connectivity to the system 100 (e.g., over the communication network 125). The process of using the trained machine learning model 107 to make predictions is described below with respect to FIG. 7.

FIG. 7 is a flowchart of a process 700 for machine learning-based ETA prediction, according to one example embodiment. In various embodiments, the mapping platform 101 and/or any of its modules/components may perform one or more portions of the process 400 and may be implemented in, for instance, a chip set including a processor and a memory as shown in FIG. 16. As such, the mapping platform 101 and/or any of its components/modules can provide means for accomplishing various parts of the process 400, as well as means for accomplishing embodiments of other processes described herein in conjunction with other components of the system 100. Although the process 400 is illustrated and described as a sequence of steps, it is contemplated that various embodiments of the process 400 may be performed in any order or combination and need not include all of the illustrated steps.

In step 701, the ETA module 303 receives a request for the ETA (e.g., ETA query 113) of a trip. The request or ETA query 113, for instance, specifies an origin, a destination, and optionally a time of departure (e.g., a tuple comprising o, d, t). In one embodiment, the request need not specify a route between the origin and destination. The origin and destination may be specified in the request as point locations, areas, places, and/or the like.

Instead, as shown in step 703, the ETA module 303 discretizes the origin to an origin ETA homogenous zone and the destination to a destination ETA homogenous zone. For example, the ETA module 303 discretizes (o, d, t) to respective TAZs or homogenous zones and optionally the time bin (e.g., 30-minute time bins) in which the origin, destination, and time fall (O_{TAZ}, D_{TAZ}, T_{BIN}). In one embodiment, the origin ETA homogenous zone, the destination ETA homogenous zone, or a combination thereof represents one or more spatial aggregations of a geographic area in which a standard deviation of the ETA at one or more common destinations is below a threshold value.

In step 705, the ETA module 303 determines one or more features associated with one or more pre-computed k-shortest paths between an origin-destination (O-D) zone pair comprising the origin ETA homogenous zone and the destination ETA homogenous zone. In embodiments in which time is considered, the ETA module 303 further discretizes the time of departure to a departure time bin. Then, the one or more features are determined further based on the departure time bin (e.g., by determining the features based on (O_{TAZ}, D_{TAZ}, T_{BIN}) versus just (O_{TAZ}, D_{TAZ}) when time is not considered.

In one embodiment, the determination of the features comprises retrieving pre-computed offline features for the O-D zone pair determined for the ETA query. For example, the ETA module 303 can query a database of pre-computed offline features 117 associated with the k-shortest paths between the O-D zone pair and optionally time bin. The offline features 117 can be pre-computed according to the various embodiments of training pipeline of the process 400 of FIG. 4 described above. Examples of these offline features are also described in the to various embodiments of the process 400.

In addition or alternatively, the determination of the features comprises computing the features online. In one embodiment, the ETA module 303 can retrieve the pre-computed k-shortest (e.g., stored in pre-computed routes database 121) for the O-D zone pair of interest. The ETA module 303 can then query data for computing the online features or otherwise directly query the online features from online features database 119. Examples of online features include but are not limited to real-time traffic, real-time weather, and/or the like that are computed at the time the ETA query 113 is made. In one embodiment, the online features database 119 can be a real-time or online map layer (e.g., live traffic layer with current travel times, traffic jams, road segment speed, live weather layer, etc.) of the geographic database 123.

In step 707, the ETA module 303 provides the one or more features as an input to a trained machine learning (e.g., trained using historical trips as described in the various embodiments of FIG. 4) to predict the ETA of the trip. For example, the ETA module 303 can construct a feature vector representing the one or more features (e.g., pre-computed offline and/or computed online) of the k-shortest paths pre-computed for the O-D zone pair, and then feed the feature vector as an ML input 115 to the machine learning model 107 (e.g., via the machine learning system 109) to determine the ETA prediction. It is noted that the only items that are computed at the time of prediction are the online features 119. The offline features 117 and k-shortest paths have already been pre-computed offline (e.g., during model training as described in the various embodiments of FIG. 4) for all or a portion of the possible O-D zone pairs in a geographic region. The discretization of the continuous origin and destination locations enables the system 100 to advantageously reduce the practically limitless possibility of continuous o-d location pairs to a significantly fewer number of discrete O-D zone pairs that can be pre-computed.

In step 709, the ETA module 303 provides the predicted ETA as an output. In one embodiment, the predicted ETA is a mean ETA for a plurality of trips between the O-D zone pair during the departure time bin. However, it is noted that although the machine learning model 107 is trained to predict mean ETAs, the prediction is performed at the individual trip level (e.g., through discretization of individual trips to O-D zone pairs).

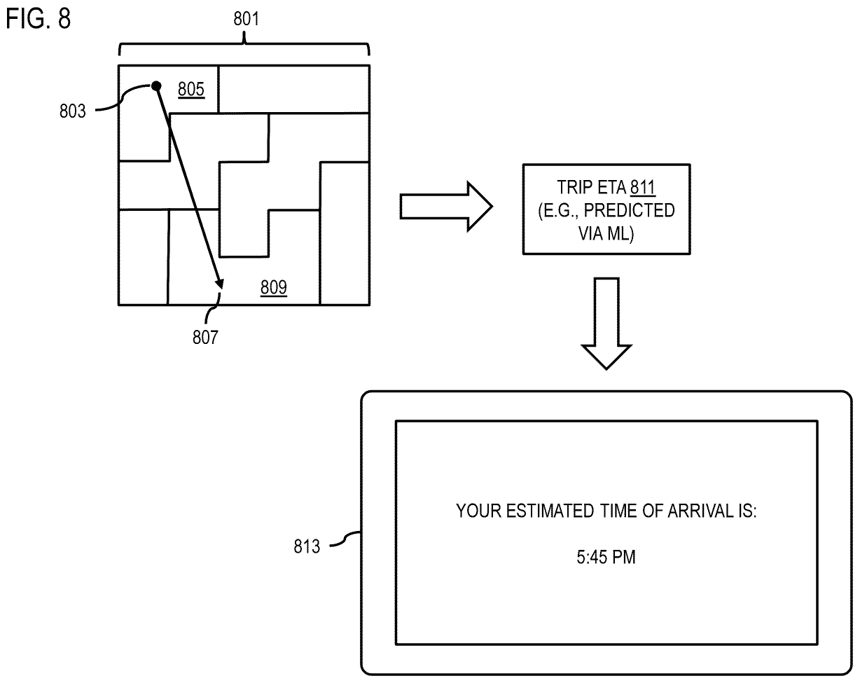

FIG. 8 is a diagram illustrating an example use case of machine learning-based ETA prediction, according to one example embodiment. In this example, homogenous zones data 103 is generated for geographic area 801 and used as part of the training of a machine learning model 107 to predict ETAs based on O-D zone pairs according to the various embodiments described herein. A user requests an ETA for a trip starting at origin 803 located in merged TAZ 805 and ending at destination 807 in merged TAZ 809. The system determines offline features pre-computed for k-shortest paths between an O-D zone pair between TAZ 805 and TAZ 809. As described in the various embodiments above, the k-shortest paths are also pre-computed and previously stored for use at the time of ETA prediction. Accordingly, no computational resources are needed to compute the offline features and the pre-computed k-shortest routes when an ETA prediction request is made. In addition, the pre-computed k-shortest routes can be used to determine online features (e.g., real-time features such as real-time traffic, real-time weather, and/or the like). The determined offline and online features are fed into the trained machine learning model 107 to predict the trip ETA 811. The trip ETA 811 is then presented in a user interface 813 of a user device as a message indicating “Your estimated time of arrival is: 5:45 pm.”

FIG. 9 is a flowchart of a process 900 for spatial aggregation for location-based services, according to one example embodiment. In various embodiments, the mapping platform 101 and/or any its modules/components may perform one or more portions of the process 900 and may be implemented in, for instance, a chip set including a processor and a memory as shown in FIG. 16. As such, the mapping platform 101 and/or any of its modules/components can provide means for accomplishing various parts of the process 900, as well as means for accomplishing embodiments of other processes described herein in conjunction with other components of the system 100. Although the process 900 is illustrated and described as a sequence of steps, it is contemplated that various embodiments of the process 900 may be performed in any order or combination and need not include all of the illustrated steps.

In one embodiment, the process 900 for spatial aggregation minimizes the number of aggregated TAZs while keeping the homogeneity of trip characteristics (e.g., ETA homogeneity) within each TAZ above certain level. To achieve this objective, the following steps are illustrated with reference to FIGS. 5A and 5B which are diagrams illustrating example criteria for spatial aggregation, according to one example embodiment.

In step 901, the partitioning module 301 divides a geographic area into a plurality of partitions or otherwise determines a plurality of partitions for a geographic area. It is contemplated that the process 900 can begin with any type of partitioning of the underlying geographic area or road network of interest. The partitioning can be based on existing partitions (e.g., map tiles at a selected zoom level determined from the geographic database 123). In addition or alternatively, when no existing partitioning is available or when existing partitions are not to be used, the partitioning module 301 can create partitions by subdividing the geographic area or road network of interest into a plurality of partitions using any partitioning means. For example, the partitioning module 301 can subdivide the geographic area or road network into uniform grid cells. The size of the initial grid cells can be selected based on the two factors described above (i.e., minimizing the number of partitions/TAZs while maintaining homogeneity of trip characteristics within each partition. After determining or creating the partitions, the partitioning module 301 selects at least two partitions (e.g., a first and second partition) to evaluate for merging.

In step 903, the partitioning module 301 determines a set of destinations that is common to a first partition and a second partition of the plurality of partitions. The set of destinations are associated with a plurality of trips originating from or ending at the first partition, the second partition, or a combination thereof. In other words, the partitioning module 301 retrieves historical trip data (e.g., from trip data 105) for the first and second partitions of data. The retrieved historical trip data can include trips that start from and/or end at the first partition and the second partition (e.g., start or end at any location within the respective geographic areas or road networks of the first and second partitions) for any destination or origin. In some embodiments, the retrieved trips can include those that include the first and/or second partitions as a waypoint on the way to a destination or from another origin/starting point.

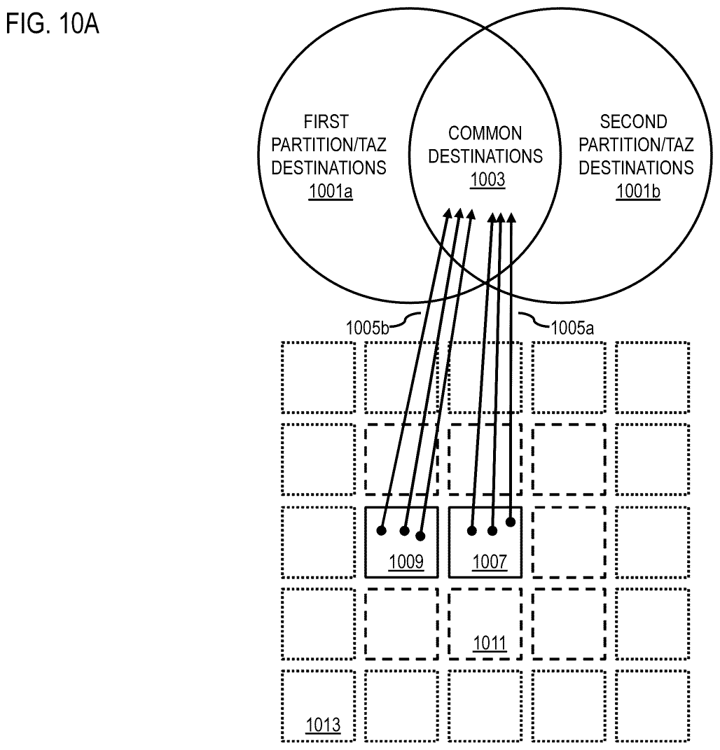

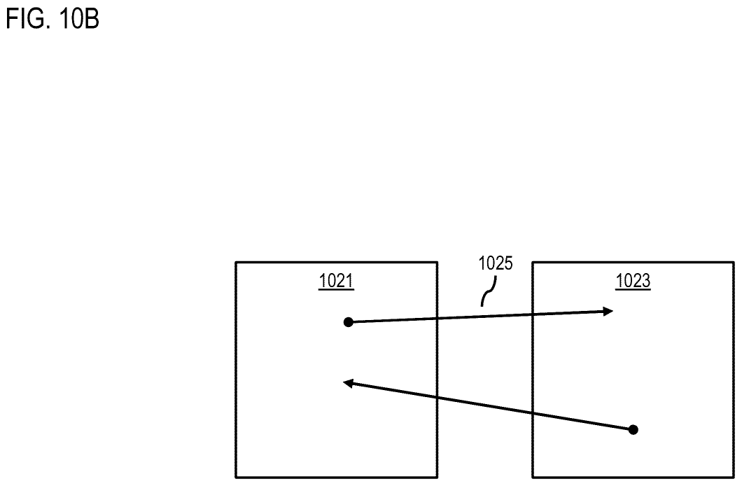

In one embodiment, as shown in FIG. 10A a first set of destinations (e.g., first partition/TAZ destinations 1001a) trips (e.g., trips 1005a) associated with the first partition (e.g., partition/TAZ 1007) and a second set of destinations (e.g., second partition/TAZ destinations 1001b) of trips (e.g., trips 1005b) associated with the second partition (e.g., partition/TAZ 1009) are obtained. The common destinations for the first and second partitions is the set of destination resulting from an intersection (e.g., common destinations 1003) of the first set and the second set. Partition/TAZ 1007 is an example of the TAZ currently being evaluated. Partition/TAZ 1009 is a an example of a candidate neighbor TAZ currently being evaluated for merging with Partition/TAZ 1007. Other partitions/TAZ s illustrated in FIG. 10A include: (1) other neighboring TAZs that are currently not being evaluated (e.g., indicated by grid cells with medium dash boundaries such as partition/TAZ 1011); (2) other TAZs (e.g., indicated by grid cells with fine dash boundaries such as partition/TAZ 1013).

In step 905, the partitioning module 301 determine a statistical property of the plurality of trips between any of the set of destinations (e.g., the common destinations determined in step 901 above) and the first partition, the second partition, or a combination thereof. By way of example, the statistical property can be based on an estimated time of arrival associated with a portion of the plurality of trips, the plurality of trips, or a combination thereof. In other words, the trip characteristic can be the ETA of the trips to the common destination or a portion/subset of those trips. Moreover, in one embodiment, the statistical property includes a standard deviation of the estimated time of arrival associated with the portion of the plurality of trips, the plurality of trips, or a combination thereof. It is noted that although various example use cases and embodiments are discussed with respect to the statistical property being a standard deviation of ETAs associated with trips from the first and second partitions, it is contemplated that any other statistical parameter (e.g., mean, maximum, minimum, mode, etc.) and/or any other trip characteristic (e.g., travel time, travel distance, speed, etc.) can be used instead of or in addition to the standard deviation of the ETA to the common destinations.

In one embodiment, the statistical property (e.g., standard deviation (std) of ETA to common destinations) is bounded when merging any two TAZs or partitions. In other words, the partitioning module 301 applies a threshold to ensure homogeneity of the statistical property for the merged TAZs or partitions. For this measure, the partitioning module 301 calculates two standard deviations for each of the common destinations for the two TAZs or partitions in question:
(1) The std of ETA (or any other selected trip characteristic) of trips originating from a TAZ (e.g., first TAZ or partition) to all common destinations; and
(2) The std of trips originating from a TAZ (e.g., first TAZ or partition) and its candidate neighbor TAZ (e.g., second TZ or partition) to all common destinations.

In other words, in one embodiment, the statistical property includes at least one of: a first statistical metric for a portion of the plurality of trips originating from the first partition to any of the plurality of destinations, or a second statistical metric for the plurality of trips originating from the first partition and the second partition. The first statistical metric and/or second statistical metric can be any statistical parameter (e.g., std, mean, maximum, mode, etc.) for any selected trip characteristic. It is contemplated that the statistical property can be tuned and need not be limited to a standard deviation of an ETA. As one example, the standard deviation could be replaced by a different statistical measure. As another example, the comparison could happen between the trips originating in each cell individually instead of calculating the statistics of the merged set of trips.

In step 907, the partitioning module 301 merges the first partition with the second partition into the traffic analysis zone based on the statistical property. For example, the partitioning module 301 compares whether the first statistical metric calculated above (e.g., std of ETA for trips originating from the first partition only) and the second statistical metric calculated above (e.g., std of ETA for trips originating from both the first partition and the second partition) are within a threshold value (e.g., std of ETA is less than a maximum threshold value). In this case, the partitioning module 301 is using the different in the two standard deviations as an indicator of homogeneity of the statistical property across the two partitions/TAZs being evaluated. If the difference of these two standard deviations (or other two statistical metrics) is within a threshold (e.g., indicating homogeneity between the two partition/TAZs), then this criterion is met and the two partitions/TAZs being evaluated can be merged into a single larger partition/TAZ (e.g., to minimum the number of TAZs that cover a given geographic area.

In other words, the first partition and the second partition (e.g., partitions being evaluated) are merged into a traffic analysis zone based on determining that the first statistical metric and the second statistical metric (e.g., respectively corresponding to each partition being evaluated) differ by less than a threshold value.

In one embodiment, the partitioning module 301 can apply an inter-TAZ or inter-partition trip count as a second threshold or criterion. Any two partitions/TAZs that pass the first criterion (e.g., statistical property criterion as illustrated in the various embodiments above) is then evaluated against a second criterion that the number of trips between the two partitions/TAZs being evaluated is below a threshold. For example, as shown in the example of FIG. 10B, a first partition/TAZ 1021 is being evaluated for merging with a second partition/TAZ 1023. The partitioning module 301 retrieves trip data comprising inter-partition trips 1025 that start from anywhere in partition/TAZ 1021 and ends anywhere in partition/TAZ 1023 or vice versa. The partitioning module 301 counts the number of inter-partition trips 1025 between the two partitions/TAZs 1021 and 1023 and will merge only if the count is below a threshold. This criterion makes sure that two partitions/TAZs that are statistically significant are not merged.

In summary, for the second merging criterion, the partitioning module 301 determines a number of inter-partition trips between the first partition and the second partition (e.g., partitions/TAZs being evaluate). The merging of the first partition and the second partition into the traffic analysis zone is then further based on the number of inter-partition trips. For example, first partition and the second partition are merged based on determining that the number of inter-partition trips is below a threshold value.

In one embodiment, the partitioning module 301 iteratively processes one or more neighboring partitions to merge into the traffic analysis zone until a stopping criterion is met. For example, the stopping criterion includes failing to merge the one or more neighboring partitions for a threshold number of consecutive iterations. In short, the process 900 works iteratively to create a spatial aggregation. For each partition/TAZ, the process 900 sequentially evaluates its neighboring partitions/TAZs (e.g., partitions/TAZs immediately adjoining the partition/TAZ being evaluated) against the merging criteria of the various embodiments described above. If the evaluation succeeds (e.g., the criteria are met), then the two partitions/TAZs being evaluated are merged. In one embodiment, convergence is reached and the iterations are stopped when the aggregation fails to merge any partition/TAZ pair for a fixed number of consecutive iterations.

Table 1 below illustrates pseudocode for implementing one embodiment of the spatial aggregation of process 900 (e.g., an embodiment that uses std of ETAs as the statistical property for aggregation).

```
TABLE 1
Ensure: Initialize threshold for standard deviation of ETAs for a common destination as
  TH1.
Ensure: Initialize threshold for inter-TAZ trips as TH2.
  1: Choose a TAZ that has not been evaluated yet. Call this current_TAZ.
  2: For current_TAZ get a list of all neighbors, call them set A.
  3: For current_TAZ enumerate all of its destinations, call this set B.
  4:
  5: for TAZs (A₁, A₂, ...) in set A do
```

| | |
|---|---|
| 6: | Calculate all destinations of TAZ Aᵢ. Call them set C. |
| 7: | Calculate intersection of sets B and C and store them in set D. |

8:

| | |
|---|---|
| 9: | for all destinations (D₁, D₂, ...) in set D do |
| 10: | Calculate the standard deviation of the ETAs for trips originating from |

current_TAZ to Dᵢ. Call it SD1.

| | |
|---|---|
| 11: | Calculate standard deviation of ETAs for trips originating from current_TAZ and |

Aᵢ combined. Call it SD2.

| | |
|---|---|
| 12: | Calculate the percentage difference between SD1 and SD2. If lower than TH1, |

mark it for merging.

| | |
|---|---|
| 13: | Calculate the number of trips in between current_TAZ and Aᵢ. If this number is |

greater than TH2, unmark it (even if it was already marked for merging).

| | |
|---|---|
| 14: | Keep the result of the previous step in a list L1. |
| 15: | end for |
| 16: | If ALL items in list L1 have been marked for merging, then current_TAZ and the |

TAZ Aᵢ are merged into a single TAZ, i.e., current_TAZ = current_TAZ + Aᵢ.
17: end for
18: Go to step 1 and continue till no more TAZs are left to
be evaluated or convergence criteria reached.

In step 909, the output module 305 provides the traffic analysis zone as an output in place of the first partition and the second partition. In other words, the partition/TAZ resulting from the merger of the first and second partitions (along with any other partition merger results) (e.g., homogenous zones data 103) are provided to replace the initial partitions.

In one example use case, digital map data of a geographic database is discretized based on the output. For example, road network data and/or any other map data are organized or indexed according to the output homogenous zones data 103. In one embodiment, the merged partitions/TAZs in the homogenous zones data 103 are used a boundaries for defining discrete units of the geographic area or road network represented in the map data (e.g., map data of the geographic database 123).

In another example use case, the output module 305 creates one or more traffic analysis zone pairs based on the output, and then processes the one or more traffic analysis zone pairs using machine learning to determine a traffic attribute. For example, the traffic attribute can be an ETA for a trip. In this use case, TAZ pairs can be determined and used to represent possible O-D pairs of a trip for computing ETA. The ETA can be pre-computed for each O-D pair so that route between the O-D pairs need not be known.

FIGS. 11-13 below provide example embodiments of spatial aggregation based on machine learning that can be used in addition to or as an alternate to the spatial aggregation of the process 900 of FIG. 9.

FIG. 11 is a flowchart of a process 1100 for spatial aggregation based on an evolutionary algorithm, according to one example embodiment. In various embodiments, the mapping platform 101 and/or any of its modules/components may perform one or more portions of the process 1100 and may be implemented in, for instance, a chip set including a processor and a memory as shown in FIG. 16. As such, the mapping platform 101 and/or any of its modules/components can provide means for accomplishing various parts of the process 1100, as well as means for accomplishing embodiments of other processes described herein in conjunction with other components of the system. Although the process 1100 is illustrated and described as a sequence of steps, it is contemplated that various embodiments of the process 1100 may be performed in any order or combination and need not include all of the illustrated steps.

The approach of the process 1100 is to create creating a population of aggregations and finding out which one is better/closer to a global metric or reaches optimal division. Optimal (Ideally) in this context is defined as a spatial aggregation that makes the task of the downstream neural network simpler (e.g., machine learning system 109). This is a posterior for which any distribution cannot be derived because any distribution of the prior is not known. The prior is a distribution, sampling from which “a” spatial aggregation can be obtained. The problem of finding an optimal spatial aggregation is exponential in the number of atomic regions/tracts/partitions/TAZ s that mapping platform 101 has at its disposal.

In one embodiment, the process 1100 solves this problem via a population-based evolutionary approach. Specifically, the mapping platform 101 can consider starting with a population of aggregation candidates which follow some aggregation rules (e.g., the homogenous zones data 103 output of the various embodiments of spatial aggregation described above or any other aggregation starting point such as but not limited to an existing division based on municipal regions) but have some minor differences (e.g., applying different aggregation thresholds for maximum acceptable standard deviation in the ETAs as per the ground truth data when aggregation is performed). These differences lead to slightly or completely different final spatial aggregation patterns. At this point, the mapping platform 101 determines a mean of the population (e.g., based on a clustering of the aggregation candidates in a population) and find a gradient for an evolutionary machine learning model that moves the general population in that direction of “evolution.” It is noted that that this population can have a few clusters or one cluster, and it is dependent on the evolutionary algorithm to handle that kind of heterogeneity in the population. Furthermore, the mapping platform 101 can select a sharp metric to steadily converge with the evolutionary algorithm.

To this end, the mapping platform 101 can use an evolutionary algorithm such as but not limited to covariance matrix adaptation evolution strategy (CMA-ES) or equivalent. CMA-ES uses a clustering algorithm to have its parameters limited to a few thousands. By way of example, CMA-ES is an evolutionary algorithm for difficult non-linear non-convex black-box optimization problems in continuous domain. CMA-ES can be applied to unconstrained or bounded constraint optimization problems, and search space dimensions between three and a hundred. CMA-ES is a second order approach estimating a positive definite matrix within an iterative procedure (more precisely: a covariance matrix, that is, on convex-quadratic functions, closely related to the inverse Hessian).

CMA-ES has several invariance properties. Two of them, inherited from the plain evolution strategy, are (i) invariance to order preserving (i.e. strictly monotonic) transformations of the objective function value (that is, e.g., ∥x∥2 and 3∥x∥0.2−100 are equivalent objective functions with identical performance of CMA-ES), and (ii) invariance to angle preserving (rigid) transformations of the search space (including rotation, reflection, and translation), if the initial search point is transformed accordingly. Invariances are highly desirable: they imply uniform behavior on classes of functions and therefore imply the generalization of empirical results.

The CMA-ES does not require a tedious parameter tuning for its application. For the application of CMA-ES, an initial solution, an initial standard deviation (step-size, variables are defined such that the same standard deviations can be reasonably applied to all variables).

Various embodiments of the steps an evolutionary algorithm of the process 1100 for spatial aggregation are discussed below.

In step 1101, the machine learning system 109 chooses or otherwise determines an initial population of spatial aggregation candidates that represents a geographic area. In one embodiment, each spatial aggregation candidate comprises a different set of traffic analysis zones or partitions representing the geographic area. In other words, each spatial aggregation candidate includes a complete set of TAZs/partitions that cover the entire geographic area or road network of interest. Each aggregation candidate will have differences relative to other aggregation candidates in the population. In one embodiment, as previously discussed, the initial population can include spatial aggregation candidates that have been generated according to the spatial aggregation of the various embodiments of process 400 of FIG. 4. The mapping platform 101 develops the population to the convergence point.

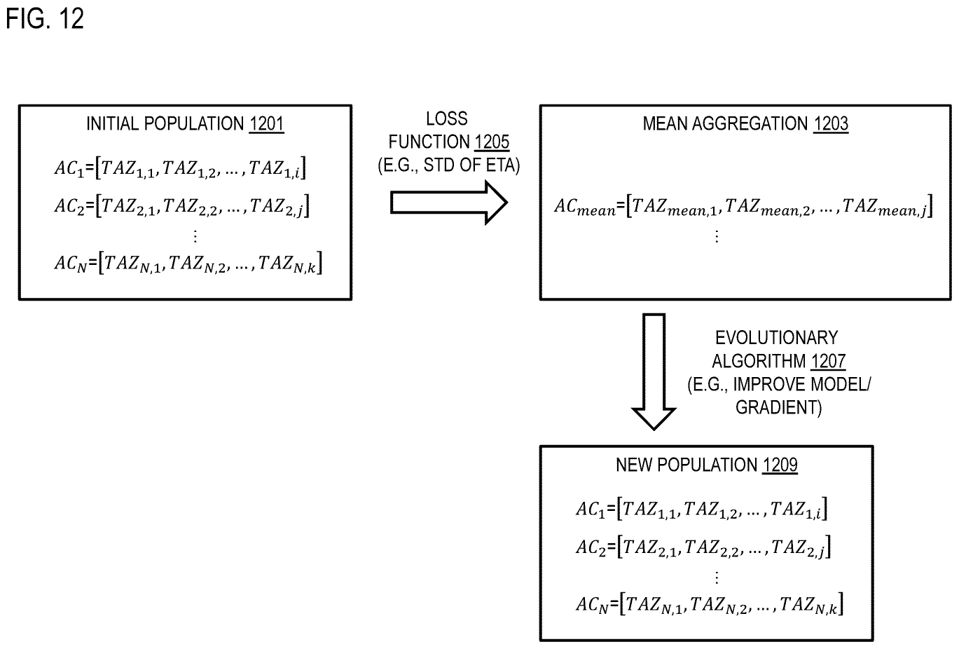

FIG. 12 is a diagram illustrating an example of using an evolutionary algorithm for spatial algorithm, according to one example embodiment. As shown, the initial population 1201 comprise a set of aggregation candidates AC₁-AC_{N}, where N is the number of aggregation candidates in a population. Each aggregation candidate AC₁-AC_{N} consists of a set of partitions or TAZs varying in number from i, j, and k. In other words, each aggregation candidate AC₁-AC_{N} can include any number of TAZs (e.g., polygons boundaries) of varying sizes and locations within the geographic area or road network associated with the population.

Once the initial population has converged, in step 1103, the machine learning system 109 determines a mean (or center) spatial aggregation of the initial population. In one embodiment, the mean or center spatial aggregation 1203 can be determined by clustering or equivalent algorithm based a loss function 1205. For example, the centers may be consolidated into candidate aggregation via a clustering algorithm. This clustering algorithm provides a loss function. In one embodiment, the loss function is based on a statistical property of a plurality of trips between any of the spatial aggregation candidates. The statistical property, for instance, is based on an estimated time of arrival of the plurality of trips. Then referring back to the determining of the initial population in step 1101, the initial population, any new population, or a combination thereof is determined based on a different threshold for a maximum standard deviation of the estimated time of arrival of the plurality of trips. In other words, a different threshold can be applied to generate each spatial aggregation in the population to create variation in between spatial aggregations (e.g., different merged partitions/TAZ s in each spatial aggregation candidate).

In step 1105, the machine learning system 109 improves the model that predicts (e.g., clustering) actions using the loss function. In other words, the machine learning system 109 determines a predictive model and/or its model parameters based on the mean spatial aggregation, the loss function, and an evolutionary algorithm (e.g., CMA-ES or equivalent indicated as evolutionary algorithm 1207 in FIG. 12).

In step 1107, the machine learning system 109 then iteratively generates a new population (e.g., new population 1209) of new spatial aggregation candidates using the predictive model until a change between the new population and a previous population (or a change in the population centers) is below a threshold value. For example, a change can be based on the similarity between the numbers, sizes, boundaries, and/or other partition characteristics between the partitions/TAZs in one population versus another. If the change or difference between any two successive iterations of the population is below a threshold value, then the iterative process can end.

In one embodiment, the machine learning system 109 determine a new mean spatial aggregation of the new population and uses the new mean spatial aggregation as traffic analysis zones for the geographic area.

In step 1109, the output module 305 provides the iteratively generated new population and//or its mean spatial aggregation as an output.

FIG. 13 is a flowchart of a process 1300 for spatial aggregation based on reinforcement learning, according to one example embodiment. In various embodiments, the mapping platform 101 and/or any of its modules/components may perform one or more portions of the process 1300 and may be implemented in, for instance, a chip set including a processor and a memory as shown in FIG. 16. As such, the mapping platform 101 and/or any of its modules/components can provide means for accomplishing various parts of the process 1300, as well as means for accomplishing embodiments of other processes described herein in conjunction with other components of the system 100. Although the process 1300 is illustrated and described as a sequence of steps, it is contemplated that various embodiments of the process 1300 may be performed in any order or combination and need not include all of the illustrated steps.

In one embodiment, the process 1300 provides an approach that uses Deep Reinforcement Learning (RL) to come up with an intelligent way for spatial partitioning for a certain task. For example, the various embodiments of the approach use a modified RL objective that does not look at discounted future rewards but at the immediate rewards. This strategy also proceeds in a step by step fashion but relies on the “learning” of the agent (e.g., powered by a neural network approximated Q-function) to make a decision at aggregating initial partitions (e.g., grid cells or tracts).

In one embodiment, the RL model comprises learning agents that take actions in an environment to maximize a cumulative reward and/or minimize a cumulative penalty. Examples of the actions and states of the learning agent include but are not limited to:
Action—The action of combining two nodes (e.g., partitions, TAZs, tracts, or equivalent) in the geographic region or road network of interest which produces a new state and also produces a reward (e.g., the change in the mean/std of the ETA or other selected statistical property).
State—The new partitioning or spatial aggregation that an action leads to among the space of possible partitions or spatial aggregations.

The model generates a reward that is not dependent on all the rewards in the roll-out, so the discount factor is zero. This particular aspect can be challenged for our use case since adding more regions, if it leads to a worsening of the ETA, then the agent must be signaled (penalized) for continuing such a “policy.” The state space is enormous since there is an exponentially large number of states possible in the order of the number of initial partitions (individual nodes of the graph).

Various embodiments of the steps a reinforcement learning algorithm of the process 1300 for spatial aggregation are discussed below.

In step 1301, the partitioning module 301 divides a geographic area into a plurality of partitions or otherwise determines a plurality of partitions for a geographic area. This partitioning step can be performed, for instance, as described with respect to step 901 of the process 900 of FIG. 9.

In step 1303, the partitioning module 301 merges a first partition and a second partition of the plurality of partitions into a traffic analysis using a reinforcement learning agent. In one embodiment, a reward of the reinforcement learning agent is based on a change in a statistical property of a plurality of trips associated with the first partition, the second partition, or a combination thereof. The reward is applied as an immediate reward.

In one embodiment, the statistical property is based on a standard deviation of an estimated time of arrival of the plurality of trips. In addition or alternatively, the statistical property can be based on any other statistical metric including but not limited to a mean, maximum, mode, etc., and the selected trip characteristics can be any other characteristics including but not limited to travel time, travel distance, speed, etc.

In one embodiment, instead of a reward, the reinforcement learning agent applies a penalty based on determining that the merging of the first partition and the second partition results in an increase of the standard deviation of the estimated time of arrival.

In step 1305, the output module 305 provides the traffic analysis zone (e.g., resulting from the reinforcement learning algorithm) as an output in place of the first partition and the second partition.

Returning to FIG. 1, as shown, the system includes the mapping platform 101 operating alone or in combination with the machine learning system 109 for providing machine learning-based ETA prediction according to the various embodiments described herein. In one embodiment, the machine learning system 109 of the mapping platform 101 includes or is otherwise associated with one or more machine learning models 107 (e.g., neural networks or other equivalent network using algorithms such as but not limited to an evolutionary algorithm, reinforcement learning, or equivalent) for performing spatial aggregation.

In one embodiment, the mapping platform 101 has connectivity over the communication network 125 to the services platform 127 that provides one or more services 129 that can use homogenous zones data 103 for the machine learning system 109 to perform one or more functions (e.g., ETA prediction). By way of example, the services 129 may be third party services and include but is not limited to mapping services, navigation services, travel planning services, notification services, social networking services, content (e.g., audio, video, images, etc.) provisioning services, application services, storage services, contextual information determination services, location based services, information based services (e.g., weather, news, etc.), etc. In one embodiment, the services 129 uses ETA data 111, homogenous zones data 103, and/or other data generated by the mapping platform 101 to provide services 129 such as navigation, mapping, other location-based services, etc. to the vehicles 133, UEs 135, and/or applications 137 executing on the UEs 135.

In one embodiment, the mapping platform 101 may be a platform with multiple interconnected components. The mapping platform 101 may include multiple servers, intelligent networking devices, computing devices, components, and corresponding software for providing spatial aggregation for location-based services according to the various embodiments described herein. In addition, it is noted that the mapping platform 101 may be a separate entity of the system 100, a part of the one or more services 129, a part of the services platform 127, or included within components of the vehicles 133 and/or UEs 135.

In one embodiment, content providers 131 may provide content or data (e.g., including geographic data, etc.) to the geographic database 123, mapping platform 101, machine learning system 109, the services platform 127, the services 129, the vehicles 133, the UEs 135, and/or the applications 137 executing on the UEs 135. The content provided may be any type of content, such as machine learning models, trip data, offline features, online features, pre-computed routes, homogenous zones data, map embeddings, map content, textual content, audio content, video content, image content, etc. In one embodiment, the content providers 131 may provide content that may aid in providing spatial aggregation for location-based services according to the various embodiments described herein. In one embodiment, the content providers 131 may also store content associated with the mapping platform 101, machine learning system 109, geographic database 123, services platform 127, services 129, and/or any other component of the system 100. In another embodiment, the content providers 131 may manage access to a central repository of data, and offer a consistent, standard interface to data, such as a repository of the geographic database 123.

In one embodiment, the vehicles 133 and/or UEs 135 may execute software applications 137 to use or access homogenous zones data 103 or data derived therefrom (e.g., ETA data 111) according the embodiments described herein. By way of example, the applications 137 may also be any type of application that is executable on the vehicles 133 and/or UEs 135, such as autonomous driving applications, mapping applications, location-based service applications, navigation applications, device control applications, content provisioning services, camera/imaging application, media player applications, social networking applications, calendar applications, and the like. In one embodiment, the applications 137 may act as a client for the mapping platform 101 and perform one or more functions associated with providing spatial aggregation for location-based services alone or in combination with the mapping platform 101.

By way of example, the vehicles 133 and/or UEs 135 is or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the vehicles 133 and/or UEs 135 can support any type of interface to the user (such as “wearable” circuitry, etc.). In one embodiment, the vehicles 133 and/or UEs 135 may be associated with or be a component of a vehicle or any other device.

In one embodiment, the communication network 125 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 101, machine learning system 109, services platform 127, services 129, vehicles 133 and/or UEs 135, and/or content providers 131 communicate with each other and other components of the system 100 using well known, new or still developing protocols. In this context, a protocol includes a set of rules defining how the network nodes within the communication network 125 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

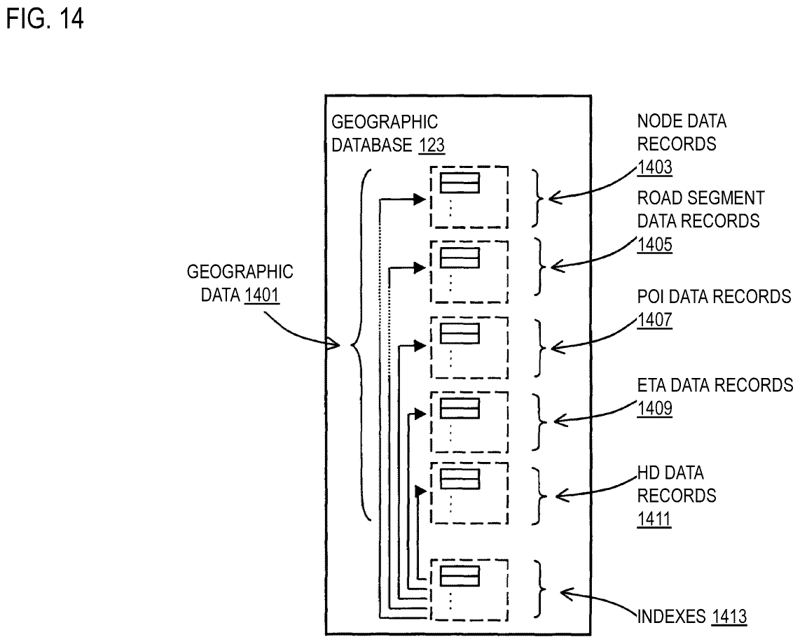

FIG. 14 is a diagram of a geographic database, according to one embodiment. In one embodiment, the geographic database 123 includes geographic data 1401 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the geographic data 1401. In one embodiment, the geographic database 123 include high definition (HD) mapping data that provide centimeter-level or better accuracy of map features. For example, the geographic database 123 can be based on Light Detection and Ranging (LiDAR) or equivalent technology to collect billions of 3D points and model road surfaces and other map features down to the number lanes and their widths. In one embodiment, the HD mapping data (e.g., HD data records 1411) capture and store details such as the slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic database 123.
“Node”— A point that terminates a link.
“Line segment”— A straight line connecting two points.
“Link” (or “edge”)— A contiguous, non-branching string of one or more line segments terminating in a node at each end.
“Shape point”— A point along a link between two nodes (e.g., used to alter a shape of the link without defining new nodes).
“Oriented link”— A link that has a starting node (referred to as the “reference node”) and an ending node (referred to as the “non reference node”).
“Simple polygon”—An interior area of an outer boundary formed by a string of oriented links that begins and ends in one node. In one embodiment, a simple polygon does not cross itself.
“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 123 follows certain conventions. For example, links do not cross themselves and do not cross each other except at a node. Also, there are no duplicated shape points, nodes, or links. Two links that connect each other have a common node. In the geographic database 123, overlapping geographic features are represented by overlapping polygons. When polygons overlap, the boundary of one polygon crosses the boundary of the other polygon. In the geographic database 123, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 123 includes node data records 1403, road segment or link data records 1405, POI data records 1407, ETA data records 1409, HD mapping data records 1411, and indexes 1413, for example. More, fewer, or different data records can be provided. In one embodiment, additional data records (not shown) can include cartographic (“carto”) data records, routing data, and maneuver data. In one embodiment, the indexes 1413 may improve the speed of data retrieval operations in the geographic database 123. In one embodiment, the indexes 1413 may be used to quickly locate data without having to search every row in the geographic database 123 every time it is accessed. For example, in one embodiment, the indexes 1413 can be a spatial index of the polygon points associated with stored feature polygons.

In exemplary embodiments, the road segment data records 1405 are links or segments representing roads, streets, or paths, as can be used in the calculated route or recorded route information for determination of one or more personalized routes. The node data records 1403 are end points (for example, representing intersections or an end of a road) corresponding to the respective links or segments of the road segment data records 1405. The road link data records 1405 and the node data records 1403 represent a road network, such as used by vehicles, cars, and/or other entities. Alternatively, the geographic database 123 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 123 can include data about the POIs and their respective locations in the POI data records 1407. The geographic database 123 can also include data about places, such as cities, towns, or other communities, and other geographic features, such as bodies of water, mountain ranges, etc. Such place or feature data can be part of the POI data records 1407 or can be associated with POIs or POI data records 1407 (such as a data point used for displaying or representing a position of a city).

In one embodiment, the geographic database 123 can also include ETA data records 1409 for storing ETA data, pre-computed routes, offline and online features, trip data, initial partitions/TAZs, merged partitions/TAZs, machine learning models, machine learning model parameters, and/or any other related data that is used or generated according to the embodiments described herein. By way of example, the ETA data records 1409 can be associated with one or more of the node records 1403, road segment records 1405, and/or POI data records 1407 to associate the ETA data with specific places, POIs, geographic areas, and/or other map features. In this way, the ETA data records 1409 can also be associated with the characteristics or metadata of the corresponding records 1403, 1405, and/or 1407.

In one embodiment, as discussed above, the HD mapping data records 1411 model road surfaces and other map features to centimeter-level or better accuracy. The HD mapping data records 1411 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 1411 are divided into spatial partitions of varying sizes to provide HD mapping data to end user devices with near real-time speed without overloading the available resources of the devices (e.g., computational, memory, bandwidth, etc. resources).

In one embodiment, the HD mapping data records 1411 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 1411.

In one embodiment, the HD mapping data records 1411 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the geographic database 123 can be maintained by the content provider 131 in association with the services platform 127 (e.g., a map developer). The map developer can collect geographic data to generate and enhance the geographic database 123. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 123 can be a master geographic database stored in a format that facilitates updating, maintenance, and development. For example, the master geographic database or data in the master geographic database can be in an Oracle spatial format or other format (e.g., capable of accommodating multiple/different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by a vehicles 133 and/or UEs 135. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing machine learning-based ETA prediction may be advantageously implemented via software, hardware (e.g., general processor, Digital Signal Processing (DSP) chip, an Application Specific Integrated Circuit (ASIC), Field Programmable Gate Arrays (FPGAs), etc.), firmware, circuitry, or a combination thereof. Such exemplary hardware for performing the described functions is detailed below.

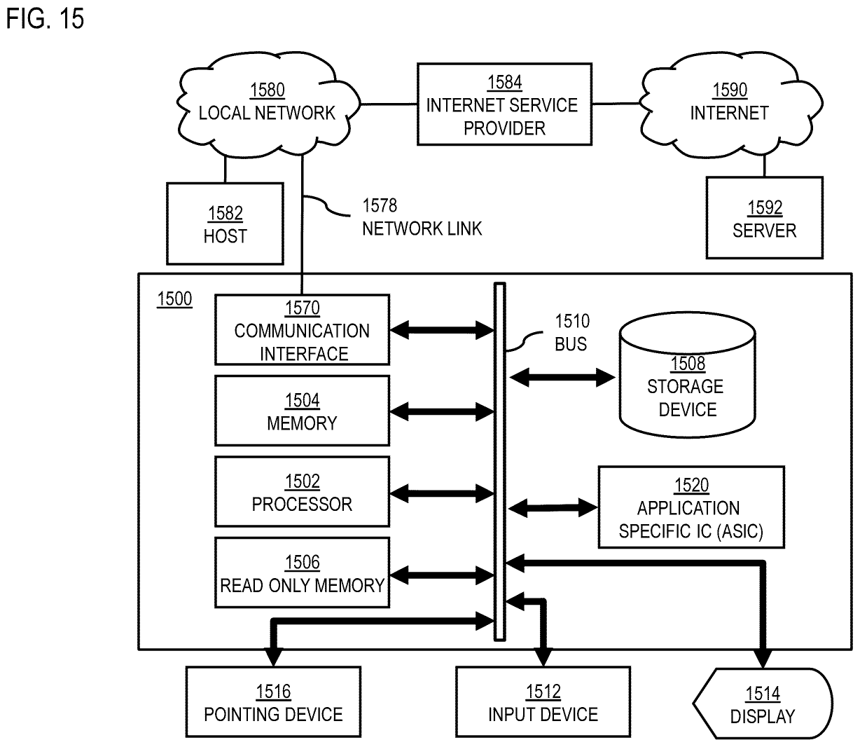

FIG. 15 illustrates a computer system 1500 upon which an embodiment of the invention may be implemented. Computer system 1500 is programmed (e.g., via computer program code or instructions) to provide machine learning-based ETA prediction as described herein and includes a communication mechanism such as a bus 1510 for passing information between other internal and external components of the computer system 1500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1510 includes one or more parallel conductors of information so that information is transferred quickly among devices coupled to the bus 1510. One or more processors 1502 for processing information are coupled with the bus 1510.

A processor 1502 performs a set of operations on information as specified by computer program code related to providing machine learning-based ETA prediction. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1510 and placing information on the bus 1510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1500 also includes a memory 1504 coupled to bus 1510. The memory 1504, such as a random access memory (RAM) or other dynamic storage device, stores information including processor instructions for providing machine learning-based ETA prediction. Dynamic memory allows information stored therein to be changed by the computer system 1500. RAM allows a unit of information stored at a location called a memory address to be stored and retrieved independently of information at neighboring addresses. The memory 1504 is also used by the processor 1502 to store temporary values during execution of processor instructions. The computer system 1500 also includes a read only memory (ROM) 1506 or other static storage device coupled to the bus 1510 for storing static information, including instructions, that is not changed by the computer system 1500. Some memory is composed of volatile storage that loses the information stored thereon when power is lost. Also coupled to bus 1510 is a non-volatile (persistent) storage device 1508, such as a magnetic disk, optical disk, or flash card, for storing information, including instructions, that persists even when the computer system 1500 is turned off or otherwise loses power.

Information, including instructions for providing machine learning-based ETA prediction, is provided to the bus 1510 for use by the processor from an external input device 1512, such as a keyboard containing alphanumeric keys operated by a human user, or a sensor. A sensor detects conditions in its vicinity and transforms those detections into physical expression compatible with the measurable phenomenon used to represent information in computer system 1500. Other external devices coupled to bus 1510, used primarily for interacting with humans, include a display device 1514, such as a cathode ray tube (CRT) or a liquid crystal display (LCD), or plasma screen or printer for presenting text or images, and a pointing device 1516, such as a mouse or a trackball or cursor direction keys, or motion sensor, for controlling a position of a small cursor image presented on the display 1514 and issuing commands associated with graphical elements presented on the display 1514. In some embodiments, for example, in embodiments in which the computer system 1500 performs all functions automatically without human input, one or more of external input device 1512, display device 1514 and pointing device 1516 is omitted.

In the illustrated embodiment, special purpose hardware, such as an application specific integrated circuit (ASIC) 1520, is coupled to bus 1510. The special purpose hardware is configured to perform operations not performed by processor 1502 quickly enough for special purposes. Examples of application specific ICs include graphics accelerator cards for generating images for display 1514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1500 also includes one or more instances of a communications interface 1570 coupled to bus 1510. Communication interface 1570 provides a one-way or two-way communication coupling to a variety of external devices that operate with their own processors, such as printers, scanners, and external disks. In general, the coupling is with a network link 1578 that is connected to a local network 1580 to which a variety of external devices with their own processors are connected. For example, communication interface 1570 may be a parallel port or a serial port or a universal serial bus (USB) port on a personal computer. In some embodiments, communications interface 1570 is an integrated services digital network (ISDN) card or a digital subscriber line (DSL) card or a telephone modem that provides an information communication connection to a corresponding type of telephone line. In some embodiments, a communication interface 1570 is a cable modem that converts signals on bus 1510 into signals for a communication connection over a coaxial cable or into optical signals for a communication connection over a fiber optic cable. As another example, communications interface 1570 may be a local area network (LAN) card to provide a data communication connection to a compatible LAN, such as Ethernet. Wireless links may also be implemented. For wireless links, the communications interface 1570 sends or receives or both sends and receives electrical, acoustic, or electromagnetic signals, including infrared and optical signals, that carry information streams, such as digital data. For example, in wireless handheld devices, such as mobile telephones like cell phones, the communications interface 1570 includes a radio band electromagnetic transmitter and receiver called a radio transceiver. In certain embodiments, the communications interface 1570 enables connection to the communication network 125 for providing machine learning-based ETA prediction.

The term computer-readable medium is used herein to refer to any medium that participates in providing information to processor 1502, including instructions for execution. Such a medium may take many forms, including, but not limited to, non-volatile media, volatile media, and transmission media. Non-volatile media include, for example, optical or magnetic disks, such as storage device 1508. Volatile media include, for example, dynamic memory 1504. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1578 typically provides information communication using transmission media through one or more networks to other devices that use or process the information. For example, network link 1578 may provide a connection through local network 1580 to a host computer 1582 or to equipment 1584 operated by an Internet Service Provider (ISP). ISP equipment 1584 in turn provides data communication services through the public, world-wide packet-switching communication network of networks now commonly referred to as the Internet 1590.

A computer called a server host 1592 connected to the Internet hosts a process that provides a service in response to information received over the Internet. For example, server host 1592 hosts a process that provides information representing video data for presentation at display 1514. It is contemplated that the components of system can be deployed in various configurations within other computer systems, e.g., host 1582 and server 1592.

FIG. 16 illustrates a chip set 1600 upon which an embodiment of the invention may be implemented. Chip set 1600 is programmed to provide machine learning-based ETA prediction as described herein and includes, for instance, the processor and memory components described with respect to FIG. 15 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1600 includes a communication mechanism such as a bus 1601 for passing information among the components of the chip set 1600. A processor 1603 has connectivity to the bus 1601 to execute instructions and process information stored in, for example, a memory 1605. The processor 1603 may include one or more processing cores with each core configured to perform independently. A multi-core processor enables multiprocessing within a single physical package. Examples of a multi-core processor include two, four, eight, or greater numbers of processing cores. Alternatively or in addition, the processor 1603 may include one or more microprocessors configured in tandem via the bus 1601 to enable independent execution of instructions, pipelining, and multithreading. The processor 1603 may also be accompanied with one or more specialized components to perform certain processing functions and tasks such as one or more digital signal processors (DSP) 1607, or one or more application-specific integrated circuits (ASIC) 1609. A DSP 1607 typically is configured to process real-world signals (e.g., sound) in real time independently of the processor 1603. Similarly, an ASIC 1609 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1603 and accompanying components have connectivity to the memory 1605 via the bus 1601. The memory 1605 includes both dynamic memory (e.g., RAM, magnetic disk, writable optical disk, etc.) and static memory (e.g., ROM, CD-ROM, etc.) for storing executable instructions that when executed perform the inventive steps described herein to provide machine learning-based ETA prediction. The memory 1605 also stores the data associated with or generated by the execution of the inventive steps.

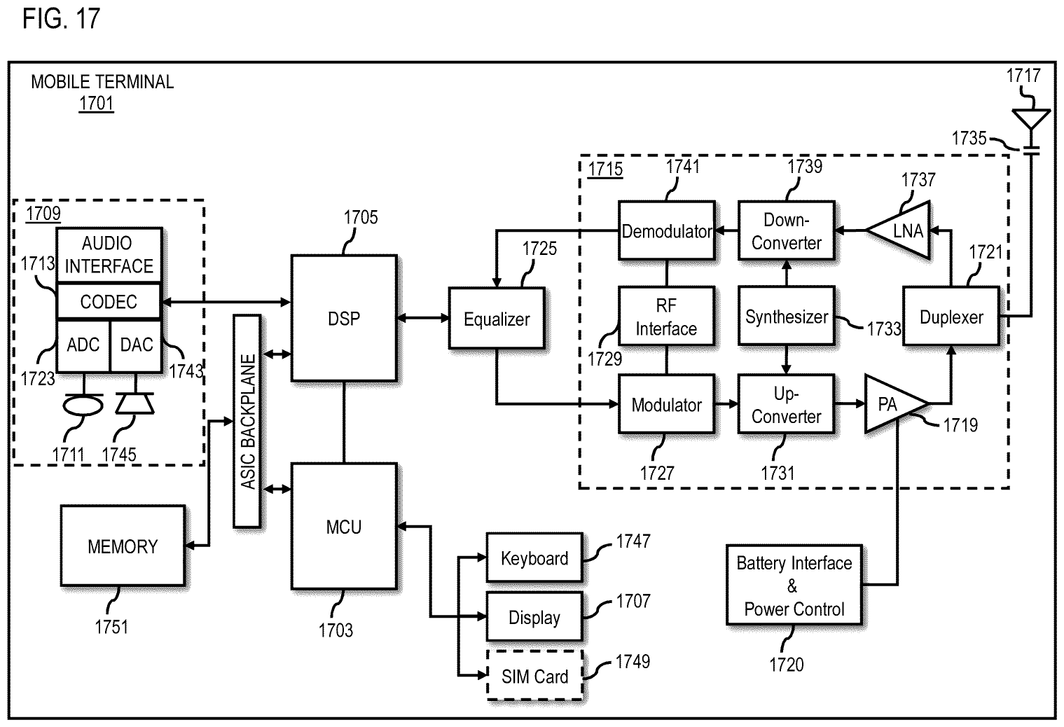

FIG. 17 is a diagram of exemplary components of a mobile terminal 1701 (e.g., a vehicles 133 and/or UE 135 or component thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1703, a Digital Signal Processor (DSP) 1705, and a receiver/transmitter unit including a microphone gain control unit and a speaker gain control unit. A main display unit 1707 provides a display to the user in support of various applications and mobile station functions that offer automatic contact matching. An audio function circuitry 1709 includes a microphone 1711 and microphone amplifier that amplifies the speech signal output from the microphone 1711. The amplified speech signal output from the microphone 1711 is fed to a coder/decoder (CODEC) 1713.

A radio section 1715 amplifies power and converts frequency in order to communicate with a base station, which is included in a mobile communication system, via antenna 1717. The power amplifier (PA) 1719 and the transmitter/modulation circuitry are operationally responsive to the MCU 1703, with an output from the PA 1719 coupled to the duplexer 1721 or circulator or antenna switch, as known in the art. The PA 1719 also couples to a battery interface and power control unit 1720.

In use, a user of mobile station 1701 speaks into the microphone 1711 and his or her voice along with any detected background noise is converted into an analog voltage. The analog voltage is then converted into a digital signal through the Analog to Digital Converter (ADC) 1723. The control unit 1703 routes the digital signal into the DSP 1705 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1725 for compensation of any frequency-dependent impairments that occur during transmission though the air such as phase and amplitude distortion. After equalizing the bit stream, the modulator 1727 combines the signal with a RF signal generated in the RF interface 1729. The modulator 1727 generates a sine wave by way of frequency or phase modulation. In order to prepare the signal for transmission, an up-converter 1731 combines the sine wave output from the modulator 1727 with another sine wave generated by a synthesizer 1733 to achieve the desired frequency of transmission. The signal is then sent through a PA 1719 to increase the signal to an appropriate power level. In practical systems, the PA 1719 acts as a variable gain amplifier whose gain is controlled by the DSP 1705 from information received from a network base station. The signal is then filtered within the duplexer 1721 and optionally sent to an antenna coupler 1735 to match impedances to provide maximum power transfer. Finally, the signal is transmitted via antenna 1717 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1701 are received via antenna 1717 and immediately amplified by a low noise amplifier (LNA) 1737. A down-converter 1739 lowers the carrier frequency while the demodulator 1741 strips away the RF leaving only a digital bit stream. The signal then goes through the equalizer 1725 and is processed by the DSP 1705. A Digital to Analog Converter (DAC) 1743 converts the signal and the resulting output is transmitted to the user through the speaker 1745, all under control of a Main Control Unit (MCU) 1703—which can be implemented as a Central Processing Unit (CPU) (not shown).

The MCU 1703 receives various signals including input signals from the keyboard 1747. The keyboard 1747 and/or the MCU 1703 in combination with other user input components (e.g., the microphone 1711) comprise a user interface circuitry for managing user input. The MCU 1703 runs a user interface software to facilitate user control of at least some functions of the mobile station 1701 to provide machine learning-based ETA prediction. The MCU 1703 also delivers a display command and a switch command to the display 1707 and to the speech output switching controller, respectively. Further, the MCU 1703 exchanges information with the DSP 1705 and can access an optionally incorporated SIM card 1749 and a memory 1751. In addition, the MCU 1703 executes various control functions required of the station. The DSP 1705 may, depending upon the implementation, perform any of a variety of conventional digital processing functions on the voice signals. Additionally, DSP 1705 determines the background noise level of the local environment from the signals detected by microphone 1711 and sets the gain of microphone 1711 to a level selected to compensate for the natural tendency of the user of the mobile station 1701.

The CODEC 1713 includes the ADC 1723 and DAC 1743. The memory 1751 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1751 may be, but not limited to, a single memory, CD, DVD, ROM, RAM, EEPROM, optical storage, or any other non-volatile or non-transitory storage medium capable of storing digital data.

An optionally incorporated SIM card 1749 carries, for instance, important information, such as the cellular phone number, the carrier supplying service, subscription details, and security information. The SIM card 1749 serves primarily to identify the mobile station 1701 on a radio network. The card 1749 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method of determining an estimated time of arrival (ETA) for a trip comprising:
receiving a request for the ETA of the trip, wherein the request specifies an origin, a destination, and a time of departure;
discretizing the origin to an origin ETA homogenous zone and the destination to a destination ETA homogenous zone;
determining one or more features associated with one or more pre-computed k-shortest paths between an origin-destination (O-D) zone pair comprising the origin ETA homogenous zone and the destination ETA homogenous zone;
providing the one or more features as an input to a trained machine learning to predict the ETA of the trip; and
providing the predicted ETA as an output.

2. The method of claim 1, further comprising:
discretizing the time of departure to a departure time bin,
wherein the one or more features are determined further based on the departure time bin.

3. The method of claim 2, wherein the predicted ETA is a mean ETA for a plurality of trips between the O-D zone pair during the departure time bin.

4. The method of claim 1, wherein the one or more features are pre-computed for the O-D zone pair.

5. The method of claim 1, wherein the one or more features are computed online.

6. The method of claim 1, wherein the origin ETA homogenous zone, the destination ETA homogenous zone, or a combination thereof represents one or more spatial aggregations of a geographic area in which a standard deviation of the ETA at one or more common destinations is below a threshold value.

7. An apparatus for training a machine learning model to predict an estimated time of arrival (ETA) comprising:
at least one processor; and
at least one memory including computer program code for one or more programs,
the at least one memory and the computer program code configured to, with the at least one processor, cause the apparatus to perform at least the following:
determine a plurality of origin-destination (O-D) zone pairs for a geographic area, wherein each O-D zone pair comprises an origin ETA homogenous zone and a destination ETA homogenous zone;
group a plurality of historical trips by the plurality of O-D zone pairs, wherein each group of the plurality of historical trips comprises a training example associated with each O-D zone pair;
for each O-D zone pair, compute a mean ETA of the plurality of historical trips grouped in each training example, one or more k-shortest paths, and one or more features of the one or more k-shortest paths;
respectively label each O-D zone pair with the mean ETA;
train a machine learning model based on the respectively labeled O-D zone pairs and the one or more features of the one or more k-shortest paths, wherein the machine learning model is trained to determine a predicted ETA based on an input O-D zone pair; and
provide the trained machine learning model as an output.

8. The apparatus of claim 7, wherein the plurality of historical trips is further grouped based on a plurality of departure time bins in combination with the plurality of O-D zone pairs; and wherein the mean ETA, the one or more k-shortest paths, the one or more features, or a combination thereof is computed based on the plurality of departure time bins.

9. The apparatus of claim 8, wherein the machine learning is further trained to determine the predicted ETA with respect to the plurality of departure time bins.

10. The apparatus of claim 7, wherein the apparatus is further caused to:
for each O-D zone pair, determine a representative origin point in the origin ETA homogenous zone and a representative destination point in the destination ETA homogenous zone,
wherein the one or more k-shortest paths are determined based on the representative origin point and the representative destination point.

11. The apparatus of claim 10, wherein the representative origin point, the representative destination point, or a combination is determined based on a minimum distance sum of a plurality of distances between a plurality of cells respectively comprising the origin ETA homogenous zone or the destination ETA homogenous zone.

12. The apparatus of claim 7, wherein the apparatus is further caused to:
store the one or more k-shortest paths, the one or more features of the one or more k-shortest paths, or a combination thereof,
wherein the one or more stored k-shortest paths, the one or more stored features, or a combination thereof is retrieved at a time the trained machine learning model is used for prediction.

13. The apparatus of claim 7, wherein an input to the trained machine learning is a tuple comprising, at least in part, an origin ETA homogenous zone identifier, a destination ETA homogenous zone identifier, and a departure time bin identifier.

14. The apparatus of claim 7, wherein each trip of the plurality of trips is represented as a tuple comprising, at least in part, a trip origin point, a trip destination point, a trip time of departure, and a trip ETA.

15. The apparatus of claim 7, wherein the origin ETA homogenous zone, the destination ETA homogenous zone, or a combination thereof represents one or more spatial aggregations of the geographic area in which a standard deviation of the ETA at one or more common destinations is below a threshold value.

16. A non-transitory computer-readable storage medium carrying one or more sequences of one or more instructions which, when executed by one or more processors, cause an apparatus to at least perform the following steps:
receiving a request for a trip characteristic of a trip, wherein the request specifies an origin, a destination, and a time of departure;
discretizing the origin to an origin homogenous zone and the destination to a destination homogenous zone;
retrieving one or more pre-computed k-shortest paths for an origin-destination (O-D) zone pair comprising the origin homogenous zone and the destination homogenous zone;
determining one or more features associated with the one or more pre-computed k-shortest paths;
providing the one or more features as an input to a trained machine learning to predict the trip characteristic; and
providing the predicted trip characteristic as an output.

17. The non-transitory computer-readable storage medium of claim 16, wherein the apparatus is caused to further perform:
discretizing the time of departure to a departure time bin,
wherein the one or more pre-computed k-shortest paths are retrieved, the one or more features are determined, or a combination thereof based on the departure time bin.

18. The non-transitory computer-readable storage medium of claim 16, wherein the predicted trip characteristic is estimated time of arrival (ETA).

19. The non-transitory computer-readable storage medium of claim 16, wherein the one or more features are pre-computed for the O-D zone pair.

20. The non-transitory computer-readable storage medium of claim 16, wherein the one or more features are computed online.
